(19) United States
(12) Patent Application Publication
(10) Pub. No.: US 2026/0342170 A1
(43) Pub. Date: Oct. 29, 2026

(54) CONNECTING BUSBAR AND MOTOR

(71) Applicant: Beyond Power Inc., Shenzhen (CN)

(72) Inventors: Changxing ZHOU, Shenzhen (CN); Sirong HUANG, Shenzhen (CN); Juncheng CHEN, Shenzhen (CN); Hongtao PAN, Shenzhen (CN); Hang YIN, Shenzhen (CN); Jiale HE, Shenzhen (CN); Jiahao YI, Shenzhen (CN); Jiehong MAI, Shenzhen (CN); Qianbin ZUO, Shenzhen (CN)

(73) Assignee: Beyond Power Inc., Shenzhen (CN)

(21) Appl. No.: 19/718,035

(22) Filed: Jun. 24, 2026

(30) Foreign Application Priority Data
Feb. 21, 2023 (CN) 202310172558.7
Feb. 21, 2023 (CN) 202310180437.7
Feb. 21, 2023 (CN) 202310186423.6
Feb. 21, 2023 (CN) 202310203074.4
Feb. 21, 2023 (CN) 202320346128.8
Feb. 21, 2023 (CN) 202320356894.2
Feb. 21, 2023 (CN) 202320364243.8
Feb. 21, 2023 (CN) 202320391256.4
Jul. 17, 2023 (CN) 202321879489.5
Sep. 28, 2023 (CN) 202322680388.1

(51) Int. Cl. H02K 5/22; B65H 75/44; H02K 9/04; H02K 11/00

(52) U.S. Cl. CPC H02K 5/225; B65H 75/4486; H02K 9/04; H02K 11/0094; H02K 2211/03

(57) ABSTRACT

A connecting busbar and a motor. The connecting busbar is configured in a motor. The motor includes multiple coils arranged in a peripheral direction. The connecting busbar includes: a mounting base, where the mounting base is an insulating member; at least one first connecting member, inserted into the mounting base, where the first connecting member includes at least two first connecting ends, and a corresponding one of the at least two first connecting ends is configured to connect to a corresponding one of the multiple coils; and at least one second connecting member, disposed on the mounting base, and including at least two second connecting ends, and a corresponding one of the at least two second connecting ends is configured to be connected to another corresponding one of the multiple coils.

### CROSS-REFERENCE TO RELATED APPLICATIONS

The present application is a continuation application of the U.S. patent application Ser. No. 19/158,453, filed on Aug. 21, 2025. The U.S. patent application Ser. No. 19/158,453 is a National Stage of International Patent Application No. PCT/CN2024/077946, filed on Feb. 21, 2024, which claims the benefit of priority to Chinese Patent Application No. 202310172558.7, filed on Feb. 21, 2023, and Chinese Patent Application No. 202310180437.7, filed on Feb. 21, 2023, and Chinese Patent Application No. 202310203074.4, filed on Feb. 21, 2023, and Chinese Patent Application No. 202310186423.6, filed on Feb. 21, 2023, and Chinese Patent Application No. 202320356894.2, filed on Feb. 21, 2023, and Chinese Patent Application No. 202320346128.8, filed on Feb. 21, 2023, and Chinese Patent Application No. 202320391256.4, filed on Feb. 21, 2023, and Chinese Patent Application No. 202320364243.8, filed on Feb. 21, 2023, and Chinese Patent Application No. 202321879489.5, filed on Jul. 17, 2023, and Chinese Patent Application No. 202322680388.1, filed on Sep. 28, 2023, all of which are incorporated by reference herein.

### TECHNICAL FIELD

The present disclosure relates to the technical field of output devices, and in particular, to a connecting busbar and a motor.

### BACKGROUND ART

Cable-type output devices are a widely used category of output devices. This type of device usually applies resistance or power to a cable. During use, a user exercises by reciprocally pulling the cable or being driven by the cable. The cable-type output device uses a reel as a storage device for the cable. A cable head of the cable is generally fixed to an end portion of a side of the reel, and then the cable can be wound around an axial direction of the reel, which facilitates retraction and release of the cable.

### SUMMARY OF THE DISCLOSURE

The present disclosure provides a connecting busbar and a motor.

According to a first aspect of the present disclosure, the connecting busbar according to some embodiments of the present disclosure is configured in a motor. The motor includes a plurality of coils arranged in a peripheral direction. The connecting busbar includes: a mounting base, where the mounting base is an insulating member; at least one first connecting member, inserted into the mounting base, where the first connecting member includes at least two first connecting ends, and a corresponding one of the at least two first connecting ends is configured to connect to a corresponding one of the plurality of coils; and at least one second connecting member, disposed on the mounting base, and including at least two second connecting ends, and a corresponding one of the at least two second connecting ends is configured to be connected to another corresponding one of the plurality of coils.

According to a second aspect of the present disclosure, the connecting busbar according to some embodiments of the present disclosure is configured in a motor. The motor includes a plurality of coils arranged in a peripheral direction. The connecting busbar includes: a mounting base, where the mounting base is an annular insulating member; a first connecting member, including two first connecting ends disposed at intervals along the peripheral direction, where the first connecting member is disposed on at least one of an inner side of the mounting base or an outer side of the mounting base, and the first connecting member is connected to two adjacent coils of the plurality of coils via the two first connecting ends; and a second connecting member, including two second connecting ends and a second connecting portion connected to the two second connecting ends, where the two second connecting ends are disposed at intervals along the peripheral direction, the second connecting portion extends along a top surface of the mounting base, and the second connecting member is connected to two spaced-apart coils of the plurality of coils via the two second connecting ends.

According to a third aspect of the present disclosure, the motor according to some embodiments of the present disclosure includes: a motor housing; a stator assembly, fixedly disposed in the motor housing; a rotor assembly, rotatably disposed in the motor housing; and a plurality of coils, arranged in a peripheral direction; and a connecting busbar, including: a mounting base, where the mounting base is an insulating member; at least one first connecting member, inserted into the mounting base, where the first connecting member includes at least two first connecting ends, where a corresponding one of the at least two first connecting ends is configured to be connected to a corresponding one of the plurality of coils; and at least one second connecting member, disposed on the mounting base, and including at least two second connecting ends, where a corresponding one of the at least two second connecting ends is configured to be connected to another corresponding one of the plurality of coils; where the plurality of coils and the connecting busbar are located on the stator assembly or on the rotor assembly.

Additional aspects and advantages of the present disclosure will be partly given in the following description, and partly will become apparent from the following description, or will be learned through the practice of the present disclosure.

### BRIEF DESCRIPTION OF THE DRAWINGS

The above and/or additional aspects and advantages of the present disclosure will become apparent and easily understood from the description of the embodiments in conjunction with the accompanying drawings.

FIG. 1 is a perspective structural view of an output device according to some embodiments of the present disclosure.

FIG. 2 is a perspective structural view of a cable housing according to some embodiments of the present disclosure.

FIG. 3 is a perspective structural view of a power supply assembly according to some embodiments of the present disclosure.

FIG. 4 is an exploded view of a partial structure of an output device according to some embodiments of the present disclosure.

FIG. 5 is a perspective structural view of an output device according to some embodiments of the present disclosure.

FIG. 6 is a partial enlarged view of portion A in FIG. 5.

FIG. 7 is a perspective structural view of an output device according to some embodiments of the present disclosure.

FIG. 8 is a partial enlarged view of portion B in FIG. 7.

FIG. 9 is a system block diagram of an output device according to some embodiments of the present disclosure.

FIG. 10 is a schematic diagram of a connection between a connecting structure and a base according to some embodiments of the present disclosure.

FIG. 11 is a schematic diagram of a connection between a connecting structure and a base according to some embodiments of the present disclosure.

FIG. 12 is a system block diagram of an output device according to some embodiments of the present disclosure.

FIG. 13 is a system block diagram of an output device according to some embodiments of the present disclosure.

FIG. 14 is a system block diagram of an output device according to some embodiments of the present disclosure.

FIG. 15 is a system block diagram of an output device according to some embodiments of the present disclosure.

FIG. 16 is a schematic diagram of combination scenarios of an output device according to some embodiments.

FIG. 17 is a structural view of a heat dissipation cover according to an embodiment of the present disclosure.

FIG. 18 is a structural view of a locking apparatus according to an embodiment of the present disclosure.

FIG. 19 is an exploded structural view of a connecting structure according to an embodiment of the present disclosure.

FIG. 20 is a partial enlarged view of portion A in FIG. 19.

FIG. 21 is a perspective structural view of a connecting structure according to some embodiments of the present disclosure.

FIG. 22 is a structural view of a connecting structure according to some embodiments of the present disclosure.

FIG. 23 is a sectional view along section B-B in FIG. 22.

FIG. 24 is a sectional view along section C-C in FIG. 22.

FIG. 25 is a schematic diagram of a cooperation between an engaging member and a first limiting groove according to some embodiments of the present disclosure.

FIG. 26 is a perspective structural view of the engaging member according to some embodiments of the present disclosure.

FIG. 27 is a structural view of a base according to some embodiments of the present disclosure.

FIG. 28 is a side view of a base according to some embodiments of the present disclosure.

FIG. 29 is a sectional view along section D-D in FIG. 28.

FIG. 30 is a perspective structural view of a connecting structure according to some embodiments of the present disclosure.

FIG. 31 is a structural view of a connecting structure according to some embodiments of the present disclosure.

FIG. 32 is a sectional view along section E-E in FIG. 31.

FIG. 33 is a side view of a connecting structure according to some embodiments of the present disclosure.

FIG. 34 is a sectional view along section F-F in FIG. 33.

FIG. 35 is a perspective structural view of a limiting protrusion according to some embodiments of the present disclosure.

FIG. 36 is a perspective structural view of a locking member according to some embodiments of the present disclosure.

FIG. 37 is a perspective structural view of a locking member from another angle according to some embodiments of the present disclosure.

FIG. 38 is a perspective structural view of a locking member from another angle according to some embodiments of the present disclosure.

FIG. 39 is a perspective structural view of a locking member from another angle according to some embodiments of the present disclosure.

FIG. 40 is a structural view of a connecting busbar according to some embodiments of the present disclosure.

FIG. 41 is a structural view of another connecting busbar according to some embodiments of the present disclosure.

FIG. 42 is a structural view of a first connecting member according to some embodiments of the present disclosure.

FIG. 43 is a structural view of another first connecting member according to some embodiments of the present disclosure.

FIG. 44 is a structural view of a second connecting member according to some embodiments of the present disclosure.

FIG. 45 is a structural view of a connection structure between a connecting member and a coil according to some embodiments of the present disclosure.

FIG. 46 is an exploded view of a motor according to some embodiments of the present disclosure.

FIG. 47 is a structural view of a stator core according to some embodiments of the present disclosure.

FIG. 48 is a structural view of a structure in which a magnetic ring is mounted on a rotor shaft according to some embodiments of the present disclosure.

FIG. 49 is a structural view of a magnetic ring according to some embodiments of the present disclosure.

FIG. 50 is a schematic diagram of a cross-sectional structure of a rear-assembled magnetic ring according to some embodiments of the present disclosure.

FIG. 51 is a structural view of a motor according to some embodiments of the present disclosure.

### DETAILED DESCRIPTION OF EMBODIMENTS

Embodiments of the present disclosure are described in detail below, and examples of the embodiments are shown in accompanying drawings, and the same or similar reference numerals represent the same or similar elements or elements having the same or similar functions. The embodiments described below with reference to the accompanying drawings are illustrative and are intended to explain the present disclosure and should not be construed as limiting the present disclosure.

In the description of the present disclosure, it should be understood that terms such as “center”, “longitudinal”, “transverse/lateral”, “length”, “width”, “thickness”, “up”, “down”, “front”, “back”, “left”, “right”, “vertical”, “horizontal”, “top”, “bottom”, “inner”, “outer”, “clockwise”, “counterclockwise”, etc., indicate orientations or positional relationships based on orientations or positional relationships shown in the accompanying drawings. These terms are used only for the convenience of describing the present disclosure and simplifying the description, and are not intended to indicate or imply that an apparatus or an element must have a specific orientation, be constructed and operated in a specific orientation, and therefore should not be construed as limiting the present disclosure. Additionally, terms such as “first” and “second” are used for descriptive purposes only and should not be construed as indicating or implying relative importance or implicitly indicating the number of technical features. Thus, features defined by “first” and “second” may explicitly or implicitly include one or more of the features. In the description of the present disclosure, the term “plurality of” means two or more, unless otherwise clearly and specifically defined.

In the description of the present disclosure, it should be noted that unless otherwise defined explicitly and specifically, terms such as “mount”, “connect”, “connection” should be understood broadly. For example, “connection” may be a fixed connection, a detachable connection, or an integral connection; or may be a mechanical connection, an electrical connection, or mutual communication; or may be a direct connection or an indirect connection through an intermediate media, or may be an internal connection of two elements or an interaction relationship between two elements. For those having ordinary skill in the art, specific meanings of the foregoing terms in the present disclosure may be understood according to specific situations.

In the present disclosure, unless otherwise defined explicitly and specifically, a first feature being “above” or “below” a second feature may include the first feature and the second feature being in direct contact, or may include the first and second features not being in direct contact but being in contact by using an additional feature between them. Moreover, a first feature being “above”, “upward”, and “on” a second feature may include the first feature being directly above and obliquely above the second feature, or only indicate that the first feature has a higher horizontal height than the second feature. A first feature being “below”, “beneath” and “underneath” the second feature includes the first feature being directly below and obliquely below the second feature, or only indicate that the first feature has a smaller horizontal height than the second feature. The term “and/or” is used to describe an association relationship for describing associated objects and represents that three relationships may exist. For example, A and/or B may represent the following three cases: Only A exists, both A and B exist, and only B exists. A, B may be singular or plural. The character “/” generally indicates an “or” relationship between the associated objects.

The following disclosure provides many different embodiments or examples to implement different structures of the present disclosure. To simplify the disclosure of the present disclosure, components and arrangements of specific embodiments are described below. Of course, these are only examples and are not intended to limit the present disclosure. Additionally, the present disclosure may repeat reference numerals and/or reference letters in different embodiments for the purpose of simplicity and clarity, which does not indicate a relationship between the various embodiments and/or arrangements discussed. Furthermore, the present disclosure provides embodiments of various specific processes and material, but those having ordinary skill in the art may be aware of the application of other processes and/or the use of other materials.

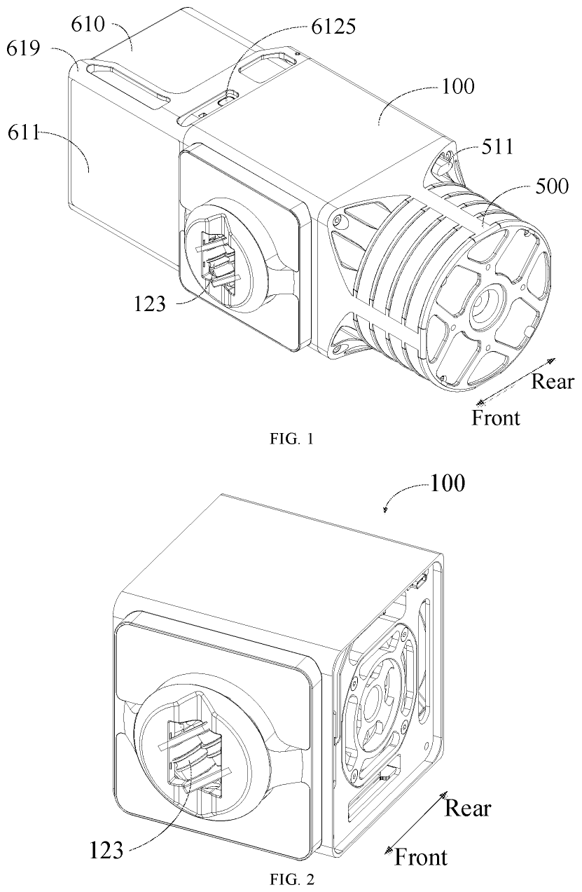

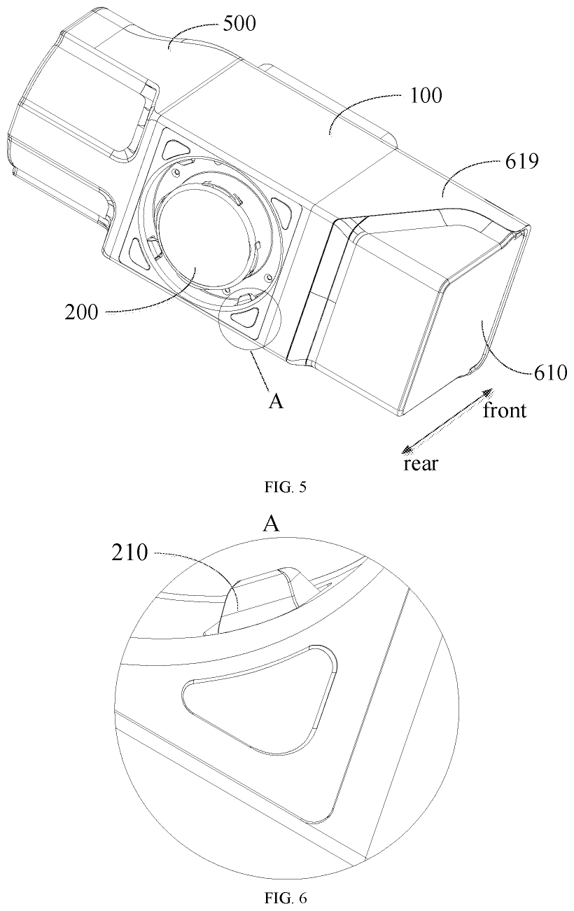

Referring to FIGS. 1-7, the output device in an embodiment of the present disclosure includes: a cable housing 100; a connecting structure 200, arranged at a rear side of the cable housing 100, and configured to be fixedly connected to a base 400, where a cable 900 in the cable housing 100 is configured to exit from a front side of the cable housing 100; a motor 500, fixedly connected to the cable housing 100 and configured to provide a traction force for the cable 900; and a power supply assembly 600, fixedly connected to the cable housing 100 and configured to supply power to the motor 500.

In an embodiment of the present disclosure, the rear side of the cable housing 100 is fixedly connected to the base 400 via the connecting structure 200, and the cable 900 is configured to exit from the front side of the cable housing 100. Thus, a lever arm may be shortened when the cable 900 is subjected to a force, so as to reduce a torque borne by the cable housing 100, which not only reduces the requirement of the strength of the cable housing 100, but also facilitates more stable fixation of the cable housing 100 on the base 400.

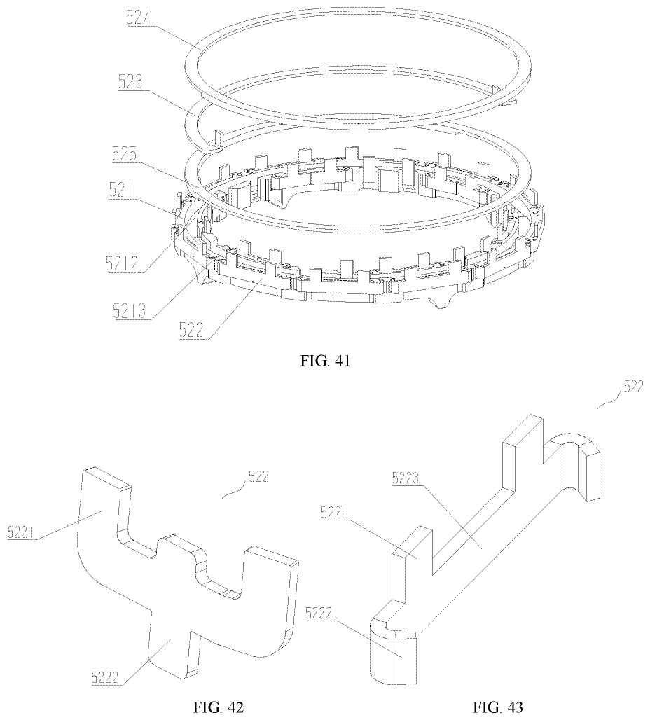

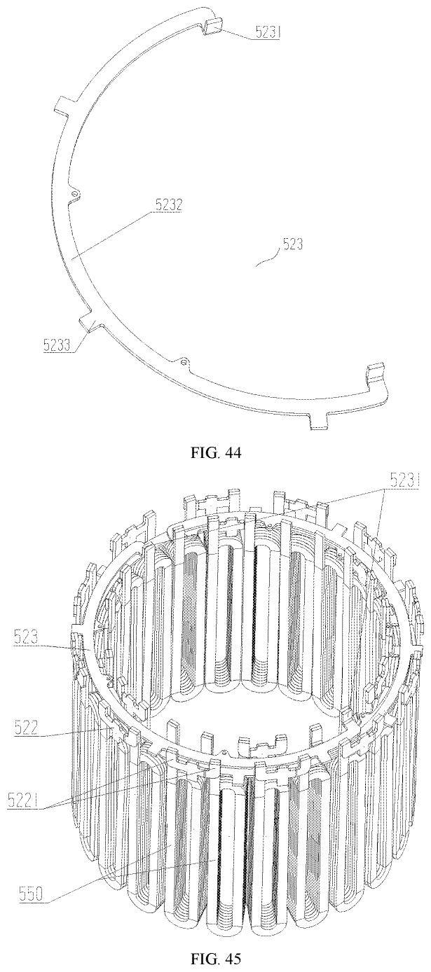

In some embodiments, the motor 500 may be fixed to the cable housing 100 by a bolt. For example, a reel, i.e., a winding reel 130 as shown in FIGS. 40-41, 55-56 and 60-65, connected to an output shaft of the motor 500 may be arranged in the cable housing 100. The cable 900 is wound around the reel and may exit from the cable housing 100 via a cable outlet wheel 123, such as a cable outlet pulley, on the front side of the cable housing 100. A torque of the motor 500 may be transmitted to the reel to achieve a traction function.

In some embodiments, the motor 500 is connected to the cable housing 100 via a detachable connection or a quick-release connection. The power supply assembly 600 is connected to the cable housing 100 via a detachable connection or a quick-release connection. In some embodiments, the motor 500 includes a series motor set 580, and the series motor set 580 includes a plurality of sub-motors 581 with power shafts connected end to end. With a detachable connection between the motor 500 and the series motor set 580, a user may reasonably series-connect a suitable number of sub-motors 581 according to the user's needs. Power shafts of adjacent sub-motors 581 may be connected end-to-end, and both ends of the power shaft penetrate through the sub-motor 581 and are connected to adjacent motors 500, which may be connected via a coupling or via a spline 573. For example, both ends of the power shaft may be connected via a spline sleeve. Alternatively, one end of the power shaft may be configured with a spline hole while an opposite end of the power shaft is configured with the spline 573. At the same time, power supplies of the sub-motors 581 in the series motor set 580 will be connected in parallel.

In some embodiments, the power supply assembly 600 is fixedly connected to the cable housing 100 via the motor 500, and the motor 500 is located between the cable housing 100 and the power supply assembly 600. In some embodiments, the motor 500 may also be located between the cable housing 100 and the power supply assembly 600, the motor 500 provides a driving force for the cable housing 100, and the power supply assembly 600 supplies power to both the motor 500 and the cable housing 100. This layout allows a product to achieve more diverse configurations, meeting user needs. In some embodiments, the power supply assembly 600 includes one or more of a battery 610, a power adapter, a connector, and a wiring rack.

When the power supply assembly 600 is the power adapter or the connector, the user may directly connect the output device to power for use, which is suitable for more application scenarios. In some embodiments, the power supply assembly 600 may also be used in combination with the battery 610, that is, the user may connect the output device to power for use, and retain the battery 610, which can meet power supply needs when power is off or when the output device is carried out, or in other situations where electricity connection is unavailable. In some embodiments, the power supply assembly 600 may also be a power-connectable rack, such as a power-connectable gantry. At this time, the cable housing 100 and the motor 500 may be directly assembled on the gantry and connected to power, which is suitable for more application scenarios.

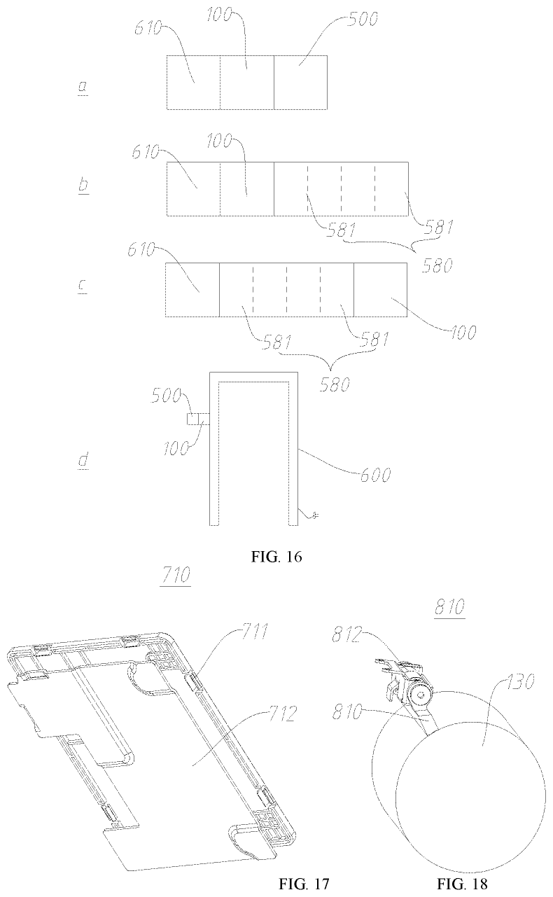

In some embodiments, as shown in FIG. 16, several possible combination scenarios are shown. FIG. 16a shows that the battery 610 and the motor 500 are located on both sides of the cable housing 100. FIG. 16b shows that the motor 500 is configured as a series motor set 580 with four sub-motors 581 connected in series. FIG. 16c shows that the series motor set 580 is located in the middle, with the battery 610 and the cable housing 100 on both sides of the series motor set 580 respectively. FIG. 16d shows that the power supply assembly 600 uses the power-connectable gantry, and the cable housing 100 and the motor 500 are connected sequentially to the power supply assembly 600. At this time, the connecting structure 200 of the cable housing 100 does not need to be fixed separately, and the gantry of the power supply assembly 600 may be configured to fix the output device.

In some embodiments, the motor 500 and the cable housing 100 are in communication with each other and define a heat dissipation channel; and/or, the cable housing 100 and the power supply assembly 600 are in communication with each other and define a heat dissipation channel; and/or, the motor 500 and the power supply assembly 600 are in communication with each other and define a heat dissipation channel.

In some embodiments, the heat dissipation channel actively dissipates heat through a heat dissipation fan 730, and the heat dissipation fan 730 is located in the heat dissipation channel.

After the motor 500, the cable housing 100, and the power supply assembly 600 are assembled, there are the heat dissipation channels in communication with each other, which may allow for ventilation and heat dissipation to help support continuous operation of the output device. For example, a channel in communication with the interior of a housing of the motor 500 may be left at a contact surface between the motor 500 and the cable housing 100, and a channel in communication with the interior of the cable housing 100 may be left at the contact surface between the cable housing 100 and the motor 500. When the motor 500 is connected to the cable housing 100, these two channels will also be in communication with each other to define the heat dissipation channel, and ventilation and heat dissipation will be performed simultaneously. In some embodiments, the heat dissipation fan 730 may also be provided to actively dissipate heat in the heat dissipation channel. The heat dissipation fan 730 may be specifically located on the cable housing 100, the motor 500, or the power supply assembly 600 and located in the heat dissipation channel.

In some embodiments, a heat dissipation cover 710 is provided on a shell 571 of the output device. A structural plate 711 can provide structural support for the heat dissipation cover 710, and the structural plate 711 has higher strength than the heat dissipation plate 712. The structural plate 711 has good thermal conductivity, and can absorb heat inside the shell 571 and transfer the heat outside the shell 571. In some embodiments, at least one heat dissipation hole 1331 is further defined on the structural plate 711 to conduct heat from the heat dissipation plate 712 to the outside. The heat dissipation plate 712 is located inside the structural plate 711. The heat dissipation plate 712 is detachably connected to the structural plate 711, to facilitate assembly and replacement. In some embodiments, the heat dissipation plate 712 is partially recessed inwardly to contact a heat-generating element in the shell 571, so as to better transfer heat to the outside. In some embodiments, the structural plate 711 includes a support portion inwardly at a position corresponding to an inward recess of the heat dissipation plate 712 to provide support, which may ensure close contact between the heat dissipation plate 712 and the heat-generating element while also transferring heat to the structural plate 711. For example, as shown in FIG. 17, the heat dissipation plate 712 and the structural plate 711 are connected by a snap-fit, and the heat dissipation plate 712 defines at least one inward recess according to a position of the heat-generating element in the shell 571, and the structural plate 711 includes the support portion at the corresponding position.

In some embodiments, a locking apparatus 810 is also provided. The locking apparatus 810 includes a movable locking arm 811. The locking arm 811 includes a first state in which the locking arm 811 contacts and presses against a locked shaft when power is off and a second state in which the locking arm 811 is away/distal from the locked shaft when power is on. The locked shaft 813 may be any winding reel 130 or any cable-guiding wheel (such as a cable-guiding pulley) through which the cable 900 passes, or a drive shaft or a motor shaft where the winding reel 130 is located, or any transmission shaft of a transmission assembly between the winding reel 130 and the motor 500. In some embodiments, when power is off, the locking arm 811 locks the locked shaft 813 via an elastic member 243, a magnetic member 1415, or a mechanical self-locking transmission assembly 814, or contacts and presses against the locked shaft 813 through friction self-locking; and/or, when power is on, the locking arm 811 may be away from the locked shaft 813 through a magnetic force of a locking electromagnet or a locking motor 812.

The output device also includes the locking apparatus 810, which is configured to lock any winding reel 130 or any cable-guiding wheel through which the cable 900 passes, or the drive shaft or the motor shaft where the winding reel 130 is located, or any transmission shaft of the transmission assembly between the winding reel 130 and the motor 500 when the device is de-energized, so as to help reduce the possibility of the winding reel 130 rotating and a load falling to ground when the load is suspended by the cable 900. At this time, the locking arm 811 is in the first state. The locking arm 811 of the locking apparatus 810 may be rotatably or slidably mounted. When the locking arm 811 is in the second state, the locking arm 811 rotates or slides away from the locked shaft 813 to stop locking, to allow the output device to operate normally. In some embodiments, the elastic member 243 or a groove configured to increase friction is provided on the contact surface between the locking arm 811 and the locked shaft 813.

In some embodiments, in the first state, a locking force exerted on the locking arm 811 is provided by an elastic force, or the magnetic force, or the mechanical self-locking transmission assembly 814. For example, the elastic force can be exerted by the elastic member 243, or the magnetic force can be exerted by the magnetic member 1415. The mechanical self-locking transmission assembly 814, such as a self-locking worm gear, can also be provided, so that the locking arm 811 can be driven by the transmission assembly to rotate and press against or leave the locked shaft 813, and cannot be driven by the locked shaft 813.

In some embodiments, in the first state, before power loss or prior to power-off, the locking motor 812 or the locking electromagnet drives the locking arm 811 to contact the locked shaft 813. At this time, a force exerted by the locking arm 811 on the transmission shaft is within a friction angle between the locking arm 811 and the transmission shaft or between the locking arm 811 and the winding reel 130, that is, the locking arm 811 can form a frictional self-locking with the transmission shaft or the winding reel 130. At this time, self-locking can be achieved without setting an additional external force, that is, after power loss or after power-off, the locking arm 811 may continue to lock the locked shaft 813 when the locking motor 812 or the electromagnet is de-energized.

In some embodiments, in the second state, the locking arm 811 is driven by the locking motor 812 or the electromagnet to rotate or slide away from the locked transmission shaft.

For example, as shown in FIG. 18, before power loss, the locking motor 812 drives the locking arm 811 to rotate into contact with the winding reel 130. After power loss, the locking motor 812 is de-energized, and the load drives the winding reel 130 via the cable 900. The rotation of the winding reel 130 further increases contact effect of the locking arm 811, thereby locking the winding reel 130. After the locking motor 812 is started, the locking motor 812 drives the locking arm 811 to rotate away from the winding reel 130, so as to release the lock.

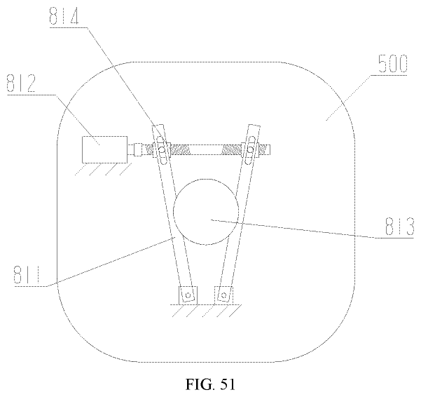

For example, as shown in FIG. 51, before power loss, the locking motor 812 drives the locking arm 811 to rotate and press against the motor shaft (the locked shaft 813) via the mechanical self-locking transmission assembly 814. After power loss, since the mechanical self-locking transmission assembly 814 is a self-locking nut-and-screw transmission, a nut connected to the locking arm 811 cannot drive a screw to rotate, thereby maintaining a locking state. When power is supplied or when power-on, the locking motor 812 drives the locking arm 811 away from the motor shaft (the locked shaft 813) via the mechanical self-locking transmission assembly 814. Two locking arms 811 are provided to lock the motor shaft (the locked shaft 813) from two directions respectively.

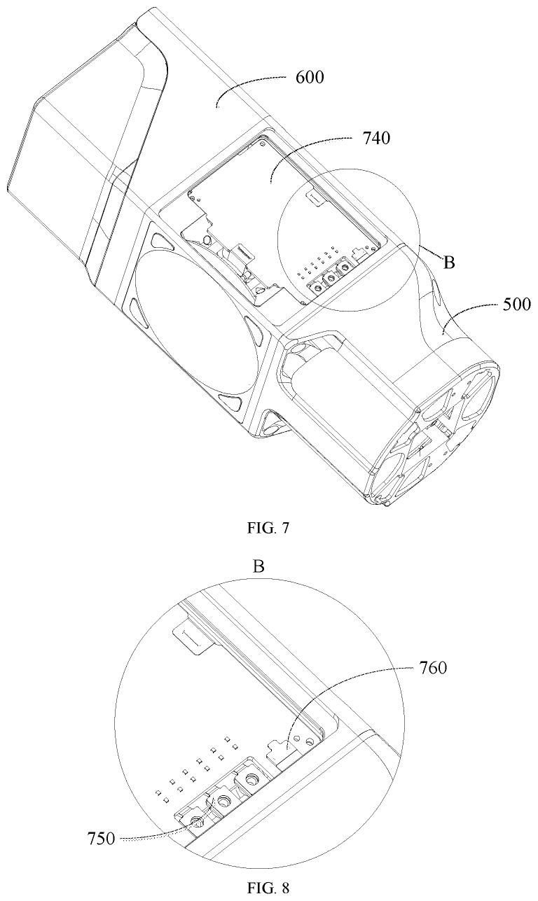

In some embodiments, referring to FIG. 1, FIG. 5, and FIG. 7, the motor 500 and the power supply assembly 600 are arranged on two opposite side surfaces of the cable housing 100.

In an embodiment, a weight of the motor 500 and a weight of the power supply assembly 600 (for example, the power supply assembly 600 may include the battery 610, etc.) are relatively large. By arranging the motor 500 and the power supply assembly 600 on the opposite sides of the cable housing 100, the weight thereof can be balanced, and a center of the output device is roughly located in the middle, which facilitates the user to hold the output device stably.

It should also be noted that when the user is accustomed to holding the output device with both hands, design of the embodiment can facilitate the user to hold the motor 500 and the power supply assembly 600 with both hands respectively, so that the user's hands bear weight evenly, which also improves the stability of holding the output device and reduces the possibility of the user accidentally dropping the output device when holding the output device.

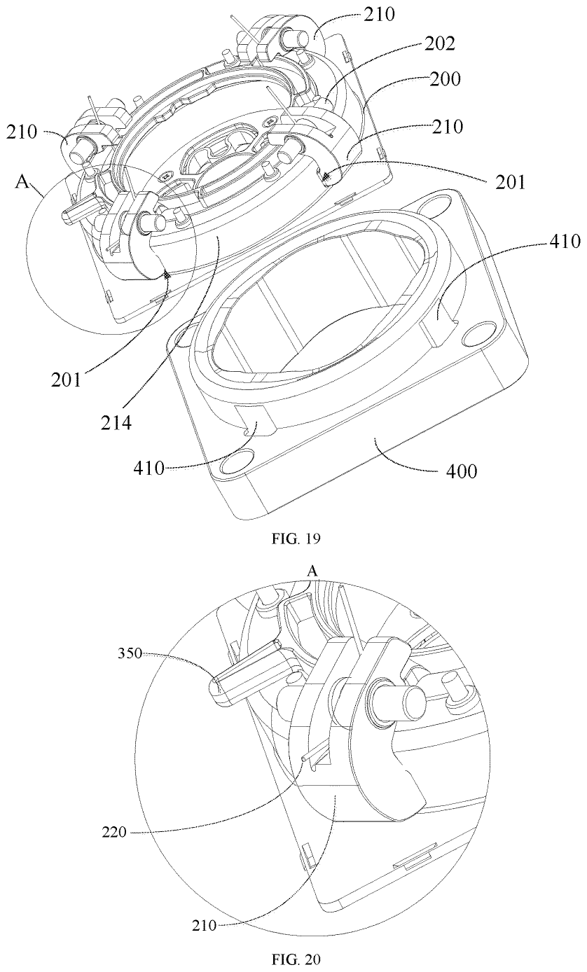

In some embodiments, referring to FIGS. 19-24, the base 400 may include a first limiting portion, and the connecting structure 200 may include a second limiting portion. The base 400 may be coupled to or connected to the connecting structure 200 in a first direction (for example, the first direction can be a MN direction in FIG. 21), and the first limiting portion and the second limiting portion may be locked along the first direction to lock the base 400 and the connecting structure 200. When it is necessary to unlock/release the base 400 from the connecting structure 200, the connecting structure 200 may be movable relative to the base 400 along a second direction to unlock the first limiting portion from the second limiting portion. In this way, the base 400 can be decoupled from the connecting structure 200 in the first direction, thereby enabling quick disassembly of the base 400 and the connecting structure 200.

Through the embodiment, when it is necessary to unlock the base 400 from the connecting structure 200, unlocking can be achieved by making the base 400 and the connecting structure 200 be movable relative to each other. The unlocking operation is convenient, the disassembly efficiency is high, which may facilitate quick disassembly of the base 400 and the connecting structure 200.

In some embodiments, the base 400 may be fixed to a fixed surface, such as a wall or a surface of another device. The connecting structure 200 may be fixedly connected to a device to be fixed, such as the output device, etc. For example, the connecting structure 200 may be fixed to the fixed device via a fixing member such as a bolt, or a screw, etc.

In an embodiment, the base 400 is coupled to the connecting structure 200 in the first direction, and the first limiting portion is locked with the second limiting portion in the first direction, so that the device to be fixed can be fixed to the fixed surface.

In an embodiment, when the device to be fixed needs to be removed, the connecting structure 200 is configured as a movable structure, so that the connecting structure 200 can be moved relative to the base 400 along the second direction, thereby enabling the first limiting portion and the second limiting portion to disengage/unlock from each other in the first direction. Thus, the device to be fixed can be removed along the first direction.

Alternatively, in some other embodiments, the difference from the above embodiments is that the connecting structure 200 can be fixed to the fixed surface, and a first device can be fixedly connected to the device to be fixed. In this way, beneficial effect of quick connection and quick disconnection between the base 400 and the connecting structure 200 can be achieved, and the details are not described in detail here.

In some embodiments, the connecting structure 200 includes at least two electrical contacts located at different positions, and the electrical contacts are connected to a short-circuit detection apparatus. In some embodiments, there are four electrical contacts, which are respectively located at the four corners of the connecting structure 200.

When the connecting structure 200 is in correct contact with the base 400, a short circuit will be formed between the electrical contacts, thereby triggering the short-circuit detection apparatus. When the connecting structure 200 is in poor contact with the base 400, the electrical contacts will not form a short circuit, and the short-circuit detection apparatus cannot detect a short-circuit signal. This indicates poor contact and a signal is sent to a controller, which can further trigger an alarm. There are at least two electrical contacts located at different positions, and the at least two electrical contacts can also be arranged in pairs at each of the different positions. For example, four electrical contacts can be arranged and respectively arranged at four corners of the connecting structure 200. When the four electrical contacts at the four corners are all electrically short-circuited with other batteries 610 and send the short-circuit signal, it indicates good contact at this time. When at least one of the electrical contacts cannot send the short-circuit signal, it indicates poor contact at this time. For example, the electrical contacts can also be arranged in four pairs at the four corners of the connecting structure 200.

The following describes possible movement modes when the base 400 is unlocked from the connecting structure 200.

In some embodiments, as shown in FIG. 21, when unlocking the connecting structure 200 from the base 400, the connecting structure 200 may be rotated relative to the base 400 (for example, the connecting structure 200 may rotate along a PQ direction in FIG. 21). For example, when unlocking is required, the connecting structure 200 can be rotated relative to the base 400. During the rotation, the first limiting portion and the second limiting portion are unlocked in the first direction, thereby achieving unlocking between the base 400 and the connecting structure 200 in the first direction, so as to facilitate separation of the base 400 and the connecting structure 200 and achieve disassembly.

In some embodiments, the base 400 can be plugged into/inserted into the connecting structure 200 in the first direction. For example, the base 400 can be at least partially embedded in the connecting structure 200 along the first direction, and the first limiting portion is engaged with the second limiting portion in the first direction, such that the locking between the base 400 and the connecting structure 200 is achieved. Alternatively, the connecting structure 200 may be at least partially embedded into the base 400 along the first direction, and the first limiting portion is engaged with the second limiting portion in the first direction, such that the locking between the base 400 and the connecting structure 200 is achieved.

In some other embodiments, when unlocking the connecting structure 200 from the base 400, the connecting structure 200 may be slidable relative to the base 400. For example, when unlocking is required, the connecting structure 200 may be slidable relative to the base 400. During a sliding process, the first limiting portion and the second limiting portion are unlocked in the first direction, so as to facilitate separation of the base 400 from the connecting structure 200, which may achieve disassembly.

The above is an exemplary illustration of movement modes when the base 400 and the connecting structure 200 are unlocked, and the embodiments of the present disclosure are not limited thereto.

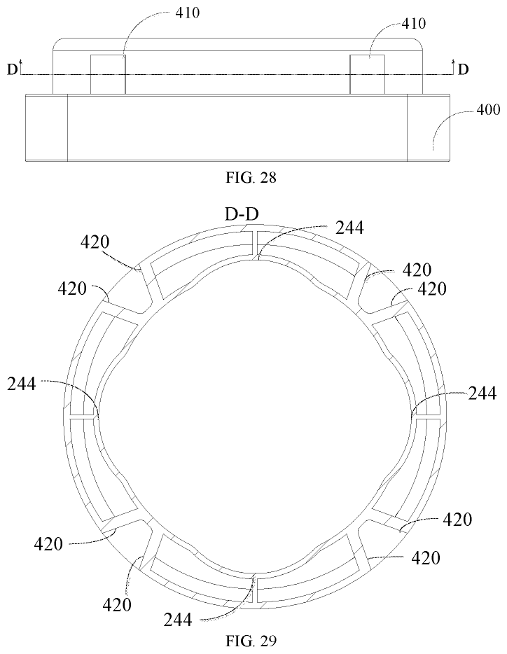

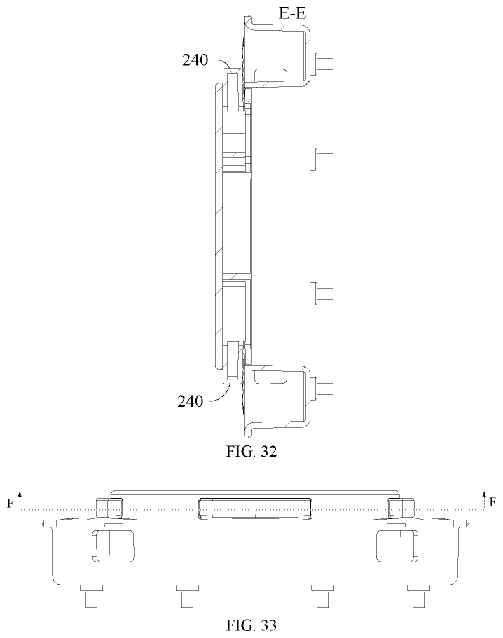

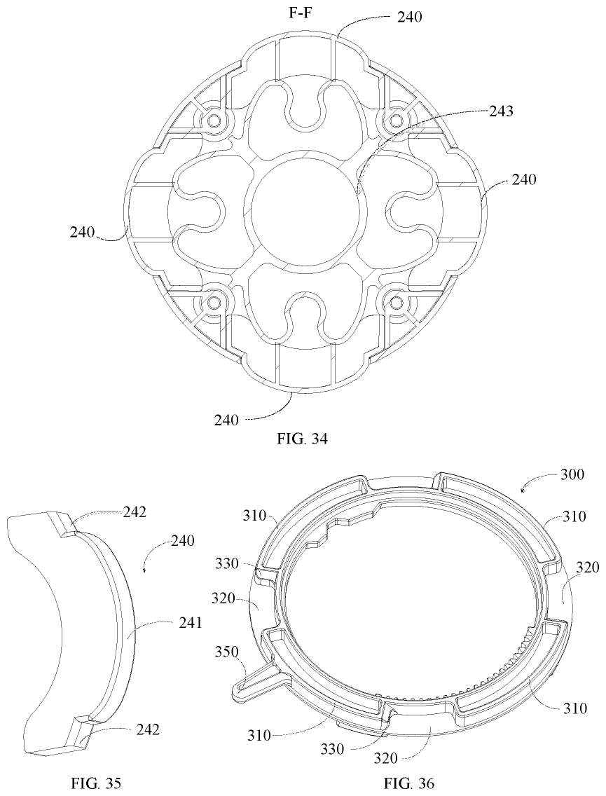

In some embodiments, referring to FIGS. 24-39, the first limiting portion may include a first limiting groove 410, and the second limiting portion may include an engaging member or a clamping member 210 movably disposed on the connecting structure 200. The engaging member 210 is inserted into/engaged with the first limiting groove 410 to lock the base 400 and the connecting structure 200 in the first direction. In the embodiment, the engaging member 210 is inserted into the first limiting groove 410 and is engaged with the first limiting groove 410 in the first direction, so that the base 400 and the connecting structure 200 are locked with each other in the first direction.

The following is an exemplary illustration of possible movement modes of the engaging member 210 on the connecting structure 200.

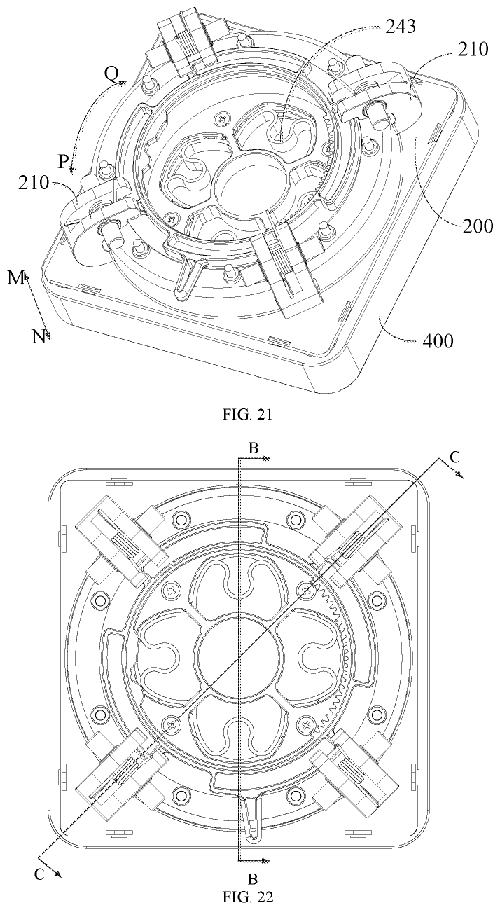

In some embodiments, the engaging member 210 may be rotatably disposed on the connecting structure 200. Referring to FIG. 22, and FIGS. 24-26, a rotation shaft 202 may be provided on the connecting structure 200, and the rotation shaft 202 passes through the engaging member 210. The engaging member 210 can rotate around the rotation shaft 202, such that the engaging member 210 may be rotatably disposed on the connecting structure 200.

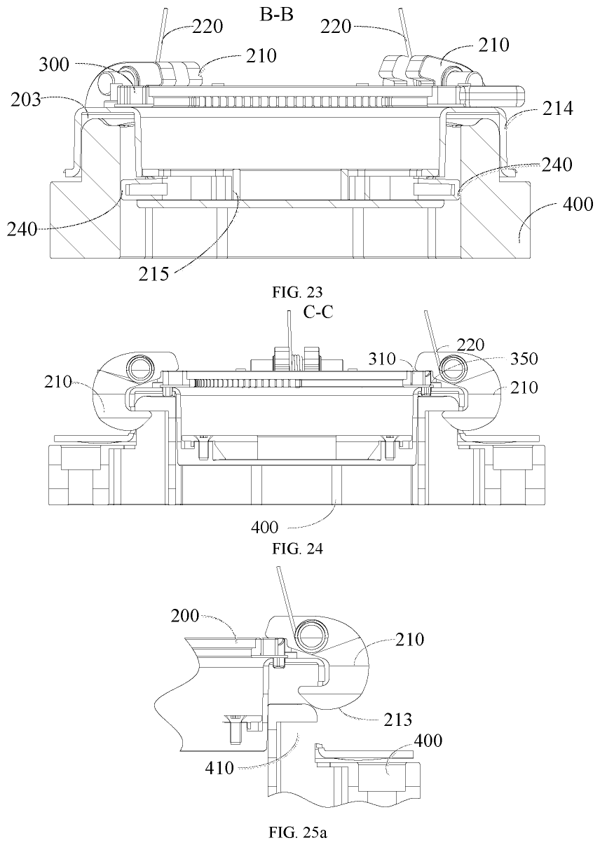

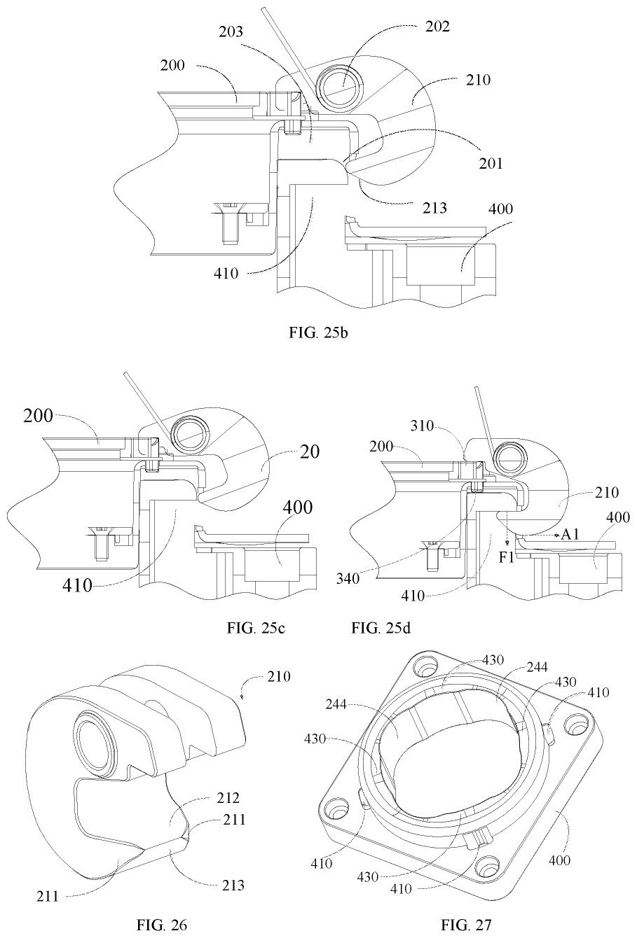

In some embodiments, as shown in FIG. 19, FIG. 23 and FIG. 25b, an insertion groove 203 may be defined on the connecting structure 200. An opening 201 may be defined in a sidewall of the insertion groove 203. The engaging member 210 may be rotatable about the rotation shaft 202 located outside the insertion groove 203. A distal end of the engaging member 210 may be extended into the insertion groove 203 through the opening 201. The engaging member 210 may be configured to be engaged into a first limiting groove 410 defined on a peripheral wall of the base 400 after the base 400 may be inserted into the insertion groove 203 along a first direction, and the base 400 and the connecting structure 200 are locked with each other in the first direction. A first guiding slope 211 may be provided on an outer sidewall of the engaging member 210. When the connecting structure 200 rotates relative to the base 400 along a peripheral direction of the insertion groove 203, a contact position between the first guiding slope 211 and an inner sidewall of the first limiting groove 410 gradually moves toward the distal end of the engaging member 210 until the distal end of the engaging member 210 may be unlocked from the first limiting groove 410, and the base 400 and the connecting structure 200 are unlocked from each other in the first direction.

In some embodiments, the insertion groove 203 may be annular. The connecting structure 200 includes an outer component 214 and an inner component 215. The insertion groove 203 may be defined by the inner component 215 and the outer component 214. The guiding protrusion may be disposed in the inner component 215 and partially exposed into the insertion groove 203 from the inner component 215.

In other embodiments, the engaging member 210 may be slidably disposed on the connecting structure 200. For example, a sliding groove may be defined on the connecting structure 200, and the engaging member 210 may cooperate with the sliding groove, such that the engaging member 210 may be slidably disposed on the connecting structure 200.

The above is an exemplary illustration of movement modes of the engaging member 210 on the connecting structure 200. It is understood that the engaging member 210 may also be other movement forms on the connecting structure 200, such as pivoting via a connecting rod, etc., and the present disclosure is not limited thereto.

In some embodiments, referring to FIGS. 20-24, the connecting structure 200 further includes a force-applying member 220 connected to the engaging member 210. The force-applying member 220 is configured to bias the engaging member 210 toward the first limiting groove 410, such that it may keep the engaging member 210 engaged with the first limiting groove 410.

In an embodiment, the force-applying member 220 can enable the engaging member 210 to maintain a tendency to move into the first limiting groove 410, thereby enabling the engaging member 210 to keep engaged with the first limiting groove 410, so as to improve the stability of the engagement between the engaging member 210 and the first limiting groove 410, which may further improve the stability of the base 400 and the connecting structure 200 being locked with each other in the first direction.

In some embodiments, when the engaging member 210 is rotatably disposed on the connecting structure 200, the force-applying member 220 may be a torsion spring. The torsion spring may be disposed around a rotation shaft 202 of the engaging member 210. Both ends of the torsion spring abut against the engaging member 210 and the connecting structure 200 respectively. The torsion spring enables the engaging member 210 to maintain a rotational tendency to rotate into the first limiting groove 410 and insert into the first limiting groove 410, such that it may keep the engaging member 210 engaged with the first limiting groove 410.

In some embodiments, when the engaging member 210 is slidably disposed on the connecting structure 200, the force-applying member 220 may be a compression spring. Both ends of the compression spring abut against the engaging member 210 and the connecting structure 200 respectively. The spring enables the engaging member 210 to maintain a tendency to extend toward a side of the first limiting groove 410, such that it may keep the engaging member 210 engaged with the first limiting groove 410.

In some embodiments, the force-applying member 220 may also be a first permanent magnet. A second permanent magnet cooperating with the first permanent magnet may be provided on the connecting structure 200 or the base 400. The first permanent magnet, for example, may be fixed on the engaging member 210. Through the interaction (such as attraction or repulsion) between the first permanent magnet and the second permanent magnet, the engaging member 210 is maintained with a tendency to move into the first limiting groove 410.

In some embodiments, referring to FIG. 26, a first guiding slope 211 is formed on an outer sidewall of the engaging member 210. A height of the first guiding slope 211 in the second direction gradually changes. When the connecting structure 200 moves relative to the base 400 along the second direction, the first guiding slope 211 can abut against the first limiting groove 410, and guide the engaging member 210 to disengage from the first limiting groove 410.

Referring to FIG. 26, the height of the first guiding slope 211 in the second direction gradually changes. For example, from a distal end of the engaging member 210 away from the connecting structure 200 to a proximal end of the engaging member 210 connected to the connecting structure 200, the height of the first guiding slope 211 in the second direction gradually increases. In other words, from the distal end of the engaging member 210 to the proximal end of the engaging member 210, the first guiding slope 211 gradually extends outward of the engaging member 210 in the second direction. Thus, when the connecting structure 200 moves relative to the base 400 in the second direction, a side of the first guiding slope 211 close to the proximal end of the engaging member 210 first abuts against a sidewall of the first limiting groove 410. Under guidance of the first guiding slope 211, the engaging member 210 gradually moves out of the first limiting groove 410, a contact position where the first guiding slope 211 contacts the first limiting groove 410 also gradually moves toward the distal end of the engaging member 210 until the distal end of the engaging member 210 disengages from the first limiting groove 410, and the engaging member 210 and the first limiting groove 410 are unlocked in the first direction.

In some embodiments, referring to FIG. 26, first guiding slopes 211 are respectively formed on two opposite outer sidewalls of the engaging member 210 in the second direction. From the proximal end of the engaging member 210 connected to the connecting structure 200 to the distal end of the engaging member 210 away from the connecting structure 200, a distance between the two first guiding slopes 211 in the second direction gradually decreases.

In the embodiment, the first guiding slopes 211 are respectively formed on two opposite sidewalls of the engaging member 210 in the second direction. From the proximal end of the engaging member 210 to the distal end of the engaging member 210, the distance between the two first guiding slopes 211 in the second direction gradually decreases. Thus, on one hand, any one of the first guiding slopes 211 can guide the engaging member 210 to unlock from the first limiting groove 410, and the connecting structure 200 can be unlocked by moving along any direction in the second direction relative to the base 400, which may improve freedom of unlocking. On the other hand, a width of the distal end of the engaging member 210 in the second direction is also reduced, which may facilitate the distal end of the engaging member 210 to smoothly insert into the first limiting groove 410, and make alignment easier during installation of the base 400 and the connecting structure 200.

In some embodiments, referring to FIGS. 27-29, a second guiding slope 420 is formed on an inner sidewall of the first limiting groove 410. A height of the second guiding slope 420 in the second direction gradually changes. When the connecting structure 200 moves relative to the base 400 along the second direction, the second guiding slope 420 can abut against the engaging member 210, and guide the engaging member 210 to disengage from the first limiting groove 410.

The height of the second guiding slope 420 in the second direction gradually changes. For example, from an outer opening of the first limiting groove 410 to an inside of the first limiting groove 410, the height of the second guiding slope 420 in the second direction gradually increases. In other words, from the outer opening of the first limiting groove 410 to the inside of the first limiting groove 410, the second guiding slope 420 gradually extends into the first limiting groove 410 in the second direction. Thus, when the connecting structure 200 moves relative to the base 400 in the second direction, the engaging member 210 first abuts against a side of the second guiding slope 420 located inside the first limiting groove 410. Under guidance of the second guiding slope 420, the engaging member 210 gradually moves out of the first limiting groove 410 until the engaging member 210 passes over a side of the second guiding slope 420 close to the outer opening of the first limiting groove 410, and the engaging member 210 moves out of the first limiting groove 410. The engaging member 210 disengages from the first limiting groove 410, and the base 400 and the connecting structure 200 are unlocked in the first direction.

In some embodiments, referring to FIG. 29, the second guiding slopes 420 are respectively formed on two opposite inner sidewalls of the first limiting groove 410 in the second direction. From the outer opening of the first limiting groove 410 to the inside of the first limiting groove 410, a distance between the two second guiding slopes 420 in the second direction gradually decreases.

In the embodiment, on one hand, any one of the second guiding slopes 420 can guide the engaging member 210 to unlock from the first limiting groove 410, and the connecting structure 200 can be unlocked by moving along any direction in the second direction relative to the base 400, which may improve freedom of unlocking. On the other hand, a width of the opening of the first limiting groove 410 in the second direction is also increased, which may facilitate the engaging member 210 to more easily engage with the limiting groove, and make alignment easier during installation of the base 400 and the connecting structure 200.

In some embodiments, referring to FIG. 25 and FIG. 26, an engaging surface 212 and a third guiding slope 213 are respectively arranged on the two opposite outer sidewalls of the engaging member 210 in the first direction. When the engaging member 210 is engaged with the first limiting groove 410, the engaging surface 212 contacts and is engaged with the first limiting groove 410 in the first direction. A height of the third guiding slope 213 in the first direction gradually changes.

In the embodiment, the engaging surface 212 of the engaging member 210 abuts against the first limiting groove 410, such that the engaging member 210 may be engaged with the first limiting groove 410. During a coupling process of the base 400 and the connecting structure 200 in the first direction, the third guiding slope 213 first contacts a plane around the first limiting groove 410 on the connecting structure 200. Since the height of the third guiding slope 213 gradually changes in the first direction, during the coupling process of the connecting structure 200 relative to the base 400 in the first direction, the third guiding slope 213 can guide the movement of the engaging member 210, which may enable the engaging member 210 to smoothly pass over an edge of the opening of the first limiting groove 410, and then the engaging surface 212 can be engaged with the first limiting groove 410.

In some embodiments, when the engaging member 210 is rotatably connected to the connecting structure 200, referring to FIG. 25(a), the third guiding slope 213 abuts against an outer sidewall of the first limiting groove 410 on the base 400. Then, referring to FIG. 25(b), the third guiding slope 213 can guide the engaging member 210 to rotate outward of the first limiting groove 410, referring to FIG. 25(c), until the engaging member 210 passes over the edge of the opening of the first limiting groove 410, the engaging member 210 rotates into the first limiting groove 410, referring to FIG. 25(d), the engaging surface 212 of the engaging member 210 is engaged with the first limiting groove 410, so that the engaging member 210 is engaged with the first limiting groove 410 in the first direction.

In some embodiments, when the engaging member 210 is slidably connected to the connecting structure 200, the third guiding slope 213 can guide the engaging member 210 to slide toward a side away from the first limiting groove 410 until the engaging member 210 passes over the edge of the opening of the first limiting groove 410. The engaging member 210 slides into the first limiting groove 410, and the engaging surface 212 of the engaging member 210 is engaged with the first limiting groove 410, so that the engaging member 210 is engaged with the first limiting groove 410 in the first direction.

In some embodiments, when the engaging member 210 is engaged with the first limiting groove 410, a force exerted by the first limiting groove 410 on the engaging member 210 is substantially perpendicular to a movement direction of the engaging member 210 when the engaging member 210 is unlocked from the first limiting groove 410.

In the embodiment, when the engaging member 210 is engaged with the first limiting groove 410, the force exerted by the first limiting groove 410 on the engaging member 210 is substantially perpendicular to the movement direction of the engaging member 210 when unlocking from the first limiting groove 410. Thus, the engaging member 210 can be self-locked, which may reduce accidental unlocking between the engaging member 210 and the first limiting groove 410, and improve the reliability of fixation between the base 400 and the connecting structure 200.

In some embodiments, when the engaging member 210 is rotatably disposed on the connecting structure 200, referring to FIG. 25(d), the movement direction of the engaging member 210 when unlocking from the first limiting groove 410 is a tangential direction of rotation of the engaging member 210 in a state shown in FIG. 25(d) (for example, a direction A1 in FIG. 25(d)). The force exerted by the first limiting groove 410 on the engaging member 210 is as shown in FIG. 25(d) (for example, a direction F1 in FIG. 25(d)), and a direction of the force is substantially perpendicular to the movement direction of the engaging member 210 when unlocking, thereby enabling the engaging member 210 to be self-locked in a current position.

In some embodiments, when the engaging member 210 is slidably disposed on the connecting structure 200, the force exerted by the first limiting groove 410 on the engaging member 210 is substantially perpendicular to a sliding direction of the engaging member 210, which can also achieve self-locking and, which may help reduce the possibility of accidental unlocking between the engaging member 210 and the first limiting groove 410.

In some embodiments, referring to FIGS. 23-25 and FIGS. 36-39, the output device may further include a locking member 300, and the locking member 300 is movably disposed on the connecting structure 200. When the engaging member 210 is locked with the first limiting groove 410, the locking member 300 may be movable relative to the connecting structure 200 and abut against the engaging member 210, which may limit the movement of the engaging member 210.

In the embodiment, the locking member 300 is configured to limit the movement of the engaging member 210 when the engaging member 210 is locked with the first limiting groove 410, thereby maintaining a locked state between the engaging member 210 and the first limiting groove 410, which may help reduce accidental unlocking between the engaging member 210 and the first limiting groove 410, so that the reliability of locking between the base 400 and the connecting structure 200 is relatively higher. When a device (e.g., the output device) is fixed via the base 400 and the connecting structure 200, the fixed device can withstand greater loads in different directions, which may improve safety of the fixed device during operation.

In some embodiments, the locking member 300 includes a first position that allows the engaging member 210 to move freely, and a second position that restricts/limits the movement of the engaging member 210. The locking member 300 can move between the first position and the second position.

In the embodiment, when the locking member 300 moves to the first position, the engaging member 210 can move freely. In other words, the engaging member 210 has freedom of movement required for unlocking from the first limiting groove 410. Thus, when the locking member 300 is located at the first position, the engaging member 210 can be moved and unlocked from the first limiting groove 410, which may enable disassembly of the base 400 and connecting structure 200. After the engaging member 210 is locked with the first limiting groove 410, when the locking member 300 moves to the second position, the locking member 300 abuts against the engaging member 210, and the locking member 300 limits the movement of the engaging member 210. At this time, the engaging member 210 cannot be unlocked from the first limiting groove 410, and the reliability of the locking between the base 400 and the connecting structure 200 is relatively higher.

In a possible embodiment, the first position may correspond to a position interval or a position range. In other words, there may be a plurality of first positions. When the locking member 300 moves to the position interval corresponding to the first position, the locking member 300 may have the freedom of movement required for unlocking from the first limiting groove 410.

In an embodiment, the locking member 300 may be slidably disposed on the connecting structure 200. For example, a sliding groove configured to accommodate the locking member 300 may be defined on the connecting structure 200. The locking member 300 is embedded in the sliding groove and can be slidable along the sliding groove to the first position and the second position, respectively. Alternatively, the sliding groove is defined on one of the locking member 300 and the connecting structure 200, and a sliding block configured to cooperate with or match the sliding groove is provided on the other of the locking member 300 and the connecting structure 200, so that the locking member 300 is slidably disposed on the connecting structure 200. With the cooperation of the sliding groove and the sliding block, the locking member 300 can slide to the first position and the second position, respectively.

In another embodiment, the locking member 300 may be rotatably disposed on the connecting structure 200, and the locking member 300 may be rotated on the connecting structure 200 to the first position and the second position, respectively.

In some embodiments, referring to FIGS. 23-25, the locking member 300 is movably disposed on the connecting structure 200, and the locking member 300 includes a limiting protrusion 310 and a clearance slot 320. When the locking member 300 moves to the second position, the limiting protrusion 310 abuts against the engaging member 210 to limit the movement of the engaging member 210. When the locking member 300 moves to the first position, the clearance slot 320 overlaps with the engaging member 210, so that the engaging member 210 has the freedom of movement for unlocking from the first limiting groove 410.

In the embodiment, when the locking member 300 moves to the second position, the limiting protrusion 310 abuts against the engaging member 210 to limit the movement of the engaging member 210, which may reduce the possibility of accidental unlocking between the engaging member 210 and the limiting protrusion 310. When the locking member 300 moves to the first position, the clearance slot 320 provides clearance for the movement of the engaging member 210, so that the engaging member 210 has the freedom of movement for unlocking from the first limiting groove 410.

In a possible embodiment, referring to FIG. 36, the clearance slot 320 may be formed by a surface of the locking member 300 being recessed downward, and a depth of the clearance slot 320 is less than a thickness of the locking member 300. The engaging member 210 can move (for example, rotate) into the clearance slot 320 and disengage from the first limiting groove 410 in the first direction, so that the engaging member 210 is unlocked from the first limiting groove 410.

In another possible embodiment, referring to FIG. 38, the clearance slot 320 may also be a through groove defined on the locking member 300. The engaging member 210 can move (e.g., rotate) in the clearance slot 320 to unlock from the first limiting groove 410.

In some embodiments, referring to FIGS. 36-38, the locking member 300 further includes a fourth guiding slope 330, and the fourth guiding slope 330 is connected to the adjacent limiting protrusion 310 and the clearance slot 320. The fourth guiding slope 330 gradually increases in height from the clearance slot 320 to the limiting protrusion 310.

In the embodiment, after the engaging member 210 is engaged with the first limiting groove 410 in the first direction, the locking member 300 can move from the first position to the second position. During the movement of the locking member 300, the fourth guiding slope 330 can contact the engaging member 210, thereby guiding the engaging member 210 to abut against the limiting protrusion 310, which may limit the movement of the engaging member 210.

In some embodiments, referring to FIGS. 19-25 and FIGS. 36-38, there are a plurality of engaging members 210, and the plurality of engaging members 210 are arranged at intervals along a peripheral direction of the connecting structure 200. The locking member 300 is annular, and the locking member 300 includes a plurality of sets of limiting protrusions 310 and clearance slots 320 corresponding to the engaging members 210. The locking member 300 can rotate relative to the connecting structure 200 and rotate to the first position or the second position. A center of the locking member 300 is coincident with a rotation axis of the locking member 300.

In the embodiment, the locking member 300 rotates around the center of the locking member 300. When the locking member 300 is located at the first position, the clearance slot 320 on the locking member 300 overlaps with a corresponding one of the engaging members 210, and the corresponding one of the engaging members 210 can move and be engaged with the first limiting groove 410. After the engaging member 210 is engaged with the first limiting groove 410, the locking member 300 can be rotated from the first position to the second position. After the locking member 300 is rotated to the second position, the limiting protrusion 310 of the locking member 300 abuts against the corresponding one of the engaging members 210, and the movement of the engaging member 210 is limited. Thus, the plurality of engaging members 210 can be locked simultaneously through rotation of the locking member 300, which may improve operational efficiency.

In some embodiments, the output device further includes a first driving motor 360, which is fixed on the connecting structure 200 and is drivingly connected to the locking member 300. The first driving motor 360 is configured to drive the locking member 300 to move.

In some embodiments, when the locking member 300 is rotatably or slidably disposed on the connecting structure 200, an output shaft of the first driving motor 360 may be in driving connection with the locking member 300 via a rack-and-pinion mechanism. Alternatively, when the locking member 300 is slidably disposed on the connecting structure 200, the first driving motor 360 may be in driving connection with the locking member 300 via a screw feed mechanism.

In a possible embodiment, the first driving motor 360 is configured to drive the locking member 300 to move in response to a first in-position signal transmitted/sent by a first position detection apparatus, so that the locking member 300 abuts against the engaging member 210. The first in-position signal is configured to indicate that the connecting structure 200 is coupled to the base 400. For example, a controller of the first driving motor 360 may be communicatively connected to the first position detection apparatus, and the controller of the first driving motor 360 may control the first driving motor 360 to operate according to the first in-position signal transmitted by the first position detection apparatus.

In the embodiment, the first position detection apparatus detects whether the base 400 is coupled to the connecting structure 200. It can be understood that when the base 400 is coupled to the connecting structure 200, the base 400 and the connecting structure 200 are mounted in place. The first driving motor 360 may drive the locking member 300 to move in response to the first in-position signal transmitted by the first position detection apparatus, such as driving the locking member 300 to move from the first position to the second position, so as to achieve the locking of the engaging member 210.

In some embodiments, the first position detection apparatus may be a Hall sensor, and a permanent magnet cooperating with the Hall sensor may be provided. One of the Hall sensor and the permanent magnet is disposed on the base 400, and the other of the Hall sensor and the permanent magnet is disposed on the connecting structure 200. After the base 400 and the connecting structure 200 are coupled in place, a magnetic field of the permanent magnet triggers the Hall sensor, and the controller of the first driving motor 360 controls the first driving motor 360 to start operating in response to the first in-position signal triggered/actuated by the Hall sensor, and the first driving motor 360 drives the locking member 300 to move.

In some embodiments, the first position detection apparatus may be a reed switch. Similarly, the reed switch may be configured in a similar manner to the Hall sensor. The cooperation between the reed switch and the permanent magnet may be configured to detect whether the base 400 and the connecting structure 200 are coupled in place, which can be achieved by referring to the foregoing embodiments, and will not be described in detail here.

In some embodiments, the first position detection apparatus may be a limit switch, which may be individually disposed on the base 400 or individually disposed on the connecting structure 200. After the base 400 and the connecting structure 200 are coupled in place, the limit switch is triggered, and the controller of the first driving motor 360 controls the first driving motor 360 to start operating in response to the triggering of the limit switch, and the first driving motor 360 drives the locking member 300 to move. In another alternative embodiment, limit switches may be respectively disposed on the base 400 and the connecting structure 200, and the controller of the first driving motor 360 may be configured to control the first driving motor 360 to start operating when both the limit switch on the base 400 and the limit switch on the connecting structure 200 are triggered, so as to reduce the possibility of false triggering of the first driving motor 360.

In another alternative embodiment, the first in-position signal is configured to indicate that the engaging member 210 is engaged with the first limiting groove 410.

In the embodiment, when the engaging member 210 is engaged with the first limiting groove 410, the first position detection apparatus transmits the first in-position signal, and the first driving motor 360 drives the locking member 300 to move in response to the first in-position signal, such as driving the locking member 300 to move from the first position to the second position, so as to achieve the locking of the engaging member 210.

In some embodiments, the first position detection apparatus may be the Hall sensor, and the permanent magnet cooperating with the Hall sensor may be provided. One of the Hall sensor and the permanent magnet is disposed on the engaging member 210, and the other of the Hall sensor and the permanent magnet is disposed on the base 400 or the connecting structure 200. After the engaging member 210 is engaged with the first limiting groove 410, the magnetic field of the permanent magnet triggers the Hall sensor, and the controller of the first driving motor 360 controls the first driving motor 360 to start operating in response to the first in-position signal triggered by the Hall sensor, and the first driving motor 360 drives the locking member 300 to move.

In some embodiments, the first position detection apparatus may be the reed switch. Similarly, the reed switch may be configured in a similar manner to the Hall sensor. The cooperation between the reed switch and the permanent magnet may be configured to detect whether the engaging member 210 is engaged with the first limiting groove 410, which can be achieved by referring to the foregoing embodiments, and will not be described in detail here.

In some embodiments, the first position detection apparatus may be the limit switch, which may be individually disposed on the base 400 or individually disposed on the connecting structure 200. After the engaging member 210 is engaged with the first limiting groove 410, the limit switch is triggered (for example, which is triggered by the engaging member 210), and the controller of the first driving motor 360 controls the first driving motor 360 to start operating in response to the triggering of the limit switch, and the first driving motor 360 drives the locking member 300 to move. In another alternative embodiment, limit switches may be respectively disposed on the base 400 and the connecting structure 200, and the controller of the first driving motor 360 may be configured to control the first driving motor 360 to start operating when both the limit switch on the base 400 and the limit switch on the connecting structure 200 are triggered, so as to reduce the possibility of false triggering of the first driving motor 360.

In some embodiments, the output device further includes a second position detection apparatus, which is communicatively connected to the first driving motor 360. The second position detection apparatus is configured to detect a current position of the locking member 300 and generate a second in-position signal when the locking member 300 moves to a preset limit position. The second in-position signal is configured to stop the first driving motor 360 that is in motion.

In some embodiments, the second position detection apparatus may be communicatively connected to the controller of the first driving motor 360, the second in-position signal transmitted by the second position detection apparatus may be sent to the controller of the first driving motor 360, and the controller of the first driving motor 360 controls the first driving motor 360 in motion to stop.

In the embodiment, the second in-position signal indicates that the locking member 300 moves to the preset limit position, and the first driving motor 360 stops operating in response to the second in-position signal, so as to achieve precise control of the first driving motor 360.

In a possible embodiment, the second position detection apparatus may be the limit switch disposed on the connecting structure 200. When the locking member 300 moves to the preset limit position, the locking member 300 triggers the limit switch.

In another possible embodiment, the second position detection apparatus may also be a photoelectric gate. When the locking member 300 moves to the preset limit position, the photoelectric gate is triggered.

In another possible embodiment, the second position detection apparatus may be a Hall element, and a permanent magnet cooperating with the Hall element may be provided. For example, the Hall element may be disposed on the connecting structure 200. For example, the permanent magnet is disposed on the locking member 300. When the locking member 300 moves to the preset limit position, the Hall element is triggered.

In another possible embodiment, the second position detection apparatus may be the reed switch, which is configured similarly to the Hall element, and will not be described in detail here.

In some embodiments, the locking member 300 is further connected to a toggle handle 350, and the toggle handle 350 extends from the connecting structure 200.

In the embodiment, the toggle handle 350 extends from the connecting structure 200, and the movement of the locking member 300 can be manually controlled by the toggle handle 350. For example, a strip groove configured to limit the movement range of the toggle handle 350 may be provided on the connecting structure 200, and the toggle handle 350 moves in the strip groove, so that the locking member 300 can move to the first position and the second position respectively.

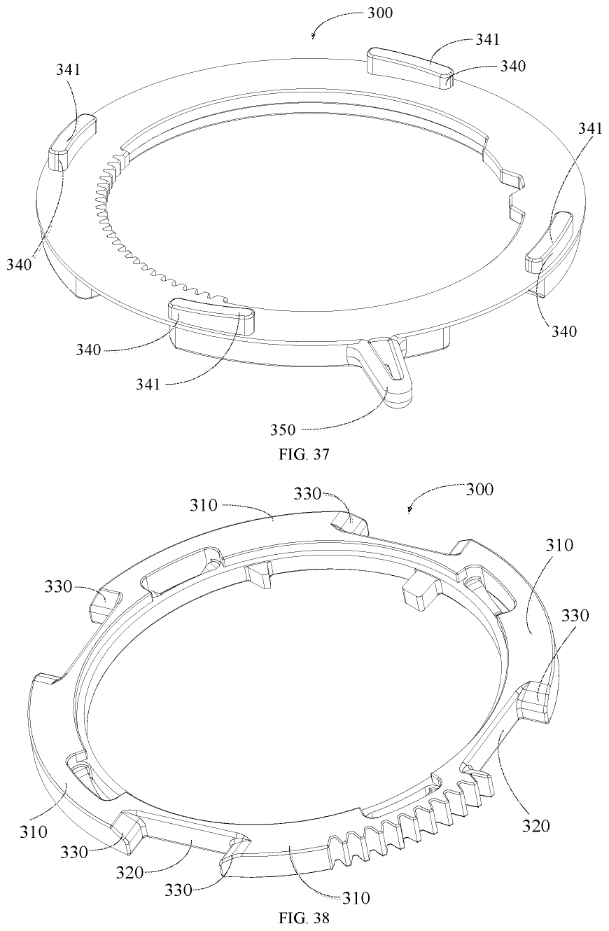

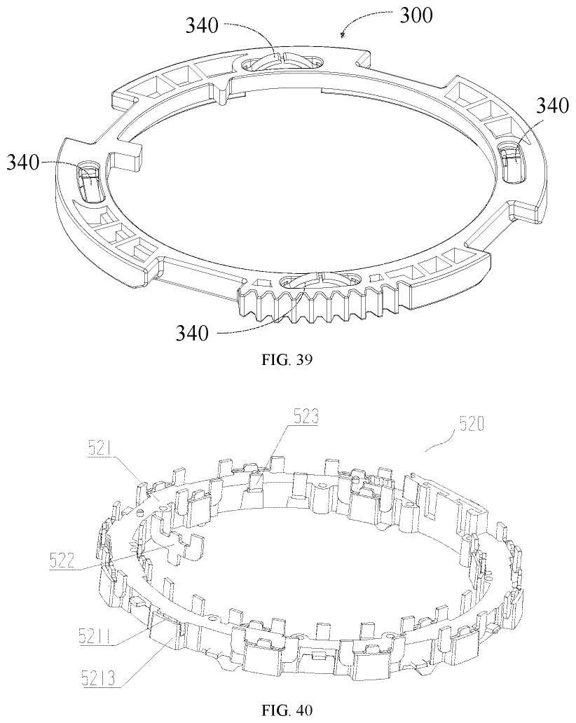

In some embodiments, referring to FIG. 24, FIG. 25, FIG. 37 and FIG. 39, the locking member 300 includes a first top block 340. When the locking member 300 moves to the second position, the first top block 340 abuts against the base 400 in the first direction.

First, the possible application background of an embodiment is described. When the first limiting portion and the second limiting portion are locked with each other, the base 400 and the connecting structure 200 can be locked with each other. However, due to factors such as processing errors and assembly errors, etc., after the base 400 and the connecting structure 200 are locked with each other, there may be a certain gap between the base 400 and the connecting structure 200, causing the base 400 and the connecting structure 200 to shake relative to each other, and affecting the stability and the reliability of the connection. For example, when the base 400 is fixed on the fixed surface and the connecting structure 200 is connected to the output device, during use of the output device, the connecting structure 200 will shake relative to the base 400, resulting in affecting the stability of the connection and also aggravating the wear of the base 400 and the connecting structure 200.

In an embodiment, by providing the first top block 340, the base 400 and the connecting structure 200 can be abutted against each other, thereby reducing the gaps caused by the processing errors, the assembly errors, etc., and improving the reliability of the connection between the base 400 and the connecting structure 200.

In an embodiment, the first top block 340 is provided on the locking member 300. When the locking member 300 moves to the second position, the locking member 300 abuts against the engaging member 210 and limits the movement of the engaging member 210, so that the engagement between the engaging member 210 and the first limiting groove 410 is more reliable. At the same time, the first top block 340 abuts against the base 400 in the first direction, and the first top block 340 can fill the gap between the base 400 and the connecting structure 200, so that the base 400 and the connecting structure 200 are locked with each other as a whole, which may reduce the possibility of shaking of the base 400 and the connecting structure 200. It should also be noted that by providing the first top block 340 on the locking member 300, reuse of a driving assembly can be achieved. That is, by driving the locking member 300, the locking of the engaging member 210 can be achieved, and the first top block 340 can be driven to abut against the connecting structure 200, which is convenient for simplifying structure and improving reliability.

In some embodiments, referring to FIG. 27, a fifth guiding slope 430 is provided on a side of the base 400 facing the connecting structure 200. Along a moving direction of the locking member 300, a height of the fifth guiding slope 430 in the first direction gradually changes. When the locking member 300 moves to the second position, the first top block 340 abuts against the fifth guiding slope 430.

In the embodiment, the height of the fifth guiding slope 430 in the first direction gradually changes. During the movement of the locking member 300, for example, the height of the fifth guiding slope 430 in the first direction gradually increases. In other words, during the movement of the locking member 300 toward the second position, a distance between the first top block 340 and the fifth guiding slope 430 gradually decreases. When the locking member 300 moves to the second position, or before the locking member 300 moves to the second position, the first top block 340 abuts against the fifth guiding slope 430. When the locking member 300 is fixed in the second position, the locking member 300 and the fifth guiding slope 430 are in a state of abutting against each other.

In one possible embodiment, before the locking member 300 moves to the second position, the first top block 340 abuts against the fifth guiding slope 430, and then, as the locking member 300 continues to move to the second position, under guiding action of the fifth guiding slope 430, the gap between the base 400 and the connecting structure 200 gradually decreases until the locking member 300 has moved to the second position. At this time, the gap between the base 400 and the connecting structure 200 is eliminated through interaction between the first top block 340 and the fifth guiding slope 430.

In some embodiments, referring to FIG. 37 and FIG. 39, a sixth guiding slope 341 is provided at an end of the first top block 340 abutting against the fifth guiding slope 430. During the movement of the locking member 300 from the first position to the second position, the sixth guiding slope 341 cooperates with the fifth guiding slope 430. In the embodiment, the sixth guiding slope 341 on the first top block 340 cooperates with the fifth guiding slope 430, so that the first top block 340 abuts against the fifth guiding slope 430 via the sixth guiding slope 341, and a sliding resistance can be reduced during a relative sliding process of the first top block 340 and the fifth guiding slope 430.

In some embodiments, before the first top block 340 abuts against the fifth guiding slope 430, the sixth guiding slope 341 and the fifth guiding slope 430 may be substantially parallel to each other. After the first top block 340 abuts against the fifth guiding slope 430, the sixth guiding slope 341 may fit with the fifth guiding slope 430.

In some embodiments, referring to FIG. 39, the first top block 340 may also be configured as a deformable structure, for example, the first top block 340 may be a cantilever structure as shown in FIG. 39. Thus, the first top block 340 may be deformed after abutting against the base 400, and may adapt to gaps of different sizes between the base 400 and the connecting structure 200, which may cause lower requirements for processing errors and assembly errors and better applicability.

In some embodiments, the connecting structure 200 further includes a first stopping protrusion 230, and the first stopping protrusion 230 is fixed on the connecting structure 200. The first stopping protrusion 230 is configured to cooperate with a second stopping protrusion on the locking member 300, which may limit the movement range of the locking member 300. In the embodiment, the first stopping protrusion 230 on the connecting structure 200 cooperates with the second stopping protrusion on the locking member 300, which may limit the movement range of the locking member 300. For example, two first stopping protrusions 230 may be provided on the connecting structure 200, and the two stopping protrusions limit a movable range of locking member 300. When the locking member 300 moves within the movable range, the locking member 300 can move to the first position and the second position respectively.

Background technology that may be applied to the following embodiments is described herein. When the base 400 is coupled to the connecting structure 200 along the first direction, alignment between the base 400 and the connecting structure 200 is usually required. However, during actual use, it is difficult for the user to quickly find a correct position during installation, resulting in the base 400 and the connecting structure 200 being misaligned. As a result, the base 400 and the connecting structure 200 may be difficult to connect normally or may have an unstable connection.

Based on this, in some embodiments, referring to FIG. 23 and FIGS. 29-35, the connecting structure 200 may further include: a retractable guiding protrusion 240, where an extending-retracting direction of the guiding protrusion 240 intersects with the first direction; an elastic member 243, configured to cooperate with the guiding protrusion 240 to keep the guiding protrusion 240 biased outward; and a guiding groove 244, configured to receive the guiding protrusion 240 after the guiding protrusion 240 extends outward or is in an extended state. The guiding protrusion 240 may be disposed on the connecting structure 200. The guiding groove 244 may be disposed on the base 400. When the first limiting portion and the second limiting portion are locked with each other, the guiding protrusion 240 is embedded in the guiding groove 244. When the connecting structure 200 moves relative to the base 400 along the second direction, the guiding protrusion 240 retracts and passes over the guiding groove 244.

In the solution, when the first limiting portion and the second limiting portion are locked with each other, the extended guiding protrusion 240 is embedded in the guiding groove 244. Since an extending direction of the guiding protrusion 240 intersects with the first direction, when the base 400 is plugged in/inserted into the connecting structure 200 along the first direction, the base 400 can be plugged in the connecting structure 200 along the first direction only when the guiding protrusion 240 is overlapped with the guiding groove 244. Thus, through an engagement between the guiding protrusion 240 and the guiding groove 244, a relative position of the base 400 and the connecting structure 200 in the second direction can be limited, so that the base 400 can only be plugged in the connecting structure 200 in at a specific position, which may facilitate the users to connect the base 400 and the connecting structure 200 in a standardized manner.

When the base 400 and the connecting structure 200 are unlocked, the base 400 and the connecting structure 200 move relative to each other along the second direction, and the guiding protrusion 240 retracts under pressing of the guiding groove 244, and finally the guiding protrusion 240 passes over the guiding groove 244. Therefore, it does not limit relative movement between the base 400 and the connecting structure 200, which may facilitate smooth unlocking of the base 400 and the connecting structure 200.

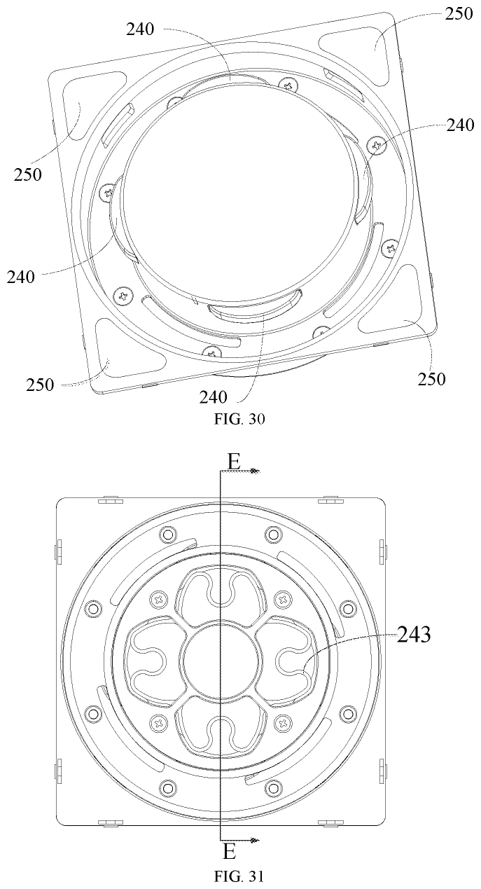

Referring to FIGS. 30-35, for example, a limiting step 242 may be disposed on the guiding protrusion 240. The limiting step 242 abuts against an inner wall of the connecting structure 200, which may help reduce an occurrence of the limiting step 242 detaching from the connecting structure 200. The elastic member 243 may be, for example, a deformable structure, and the elastic member 243 abuts against an inner wall of the guiding protrusion 240. When the guiding protrusion 240 extends from a quick-release member, the limiting step 242 of the guiding protrusion 240 abuts against the inner wall of the connecting structure 200, and the inner side of the guiding protrusion 240 abuts against the elastic member 243.

Of course, the elastic member 243 may also be a spring, which will not be described in detail here.

In some embodiments, referring to FIG. 35, a seventh guiding slope 241 is disposed on a side of the guiding protrusion 240 cooperating with the guiding groove 244. A height of the seventh guiding slope 241 gradually changes along the second direction.

In this solution, the seventh guiding slope 241 can guide the guiding protrusion 240 to be embedded in the guiding groove 244, or guide the guiding protrusion 240 to pass over the first limiting groove 410. In some embodiments, when the base 400 is coupled to the connecting structure 200 along the first direction, when the guiding protrusion 240 is not completely aligned with the guiding groove 244, the seventh guiding slope 241 abuts against the first limiting groove 410, so as to provide a force or a torque to guide and align the guiding protrusion 240, thereby guiding the guiding protrusion 240 to align with the first limiting groove 410, and further aligning the base 400 with the connecting structure 200. During an unlocking process of the base 400 and the connecting structure 200, the base 400 and the connecting structure 200 move relatively in the second direction, and at this time, the seventh guiding slope 241 can abut against the guiding groove 244. A force exerted by the guiding groove 244 on the seventh guiding slope 241 causes the guiding protrusion 240 to gradually retract, and finally the guiding protrusion 240 passes over the guiding groove 244 under guidance of the seventh guiding slope 241, so as to achieve smooth unlocking of the base 400 and the connecting structure 200.

In some embodiments, referring to FIG. 35, along the second direction, the height of the seventh guiding slope 241 first increases and then decreases.

In the embodiment, along the second direction, the height of the seventh guiding slope 241 first increases and then decreases, so that when the base 400 and the connecting structure 200 move relatively toward either side in the second direction, the guiding protrusion 240 can be retracted through guiding action of the seventh guiding slope 241, so that the guiding protrusion 240 passes over the first limiting groove 410, thereby achieving smooth unlocking of the base 400 and the connecting structure 200.

In some embodiments, the base 400 and the connecting structure 200 can rotate relative to each other along the second direction. At a viewing angle shown in FIG. 22, the connecting structure 200 can rotate clockwise or counterclockwise relative to the base 400, both of which can enable the guiding protrusion 240 to pass over the first limiting groove 410, so that bidirectional unlocking of the connecting structure 200 and the base 400 can be achieved, and it is more convenient for the user to use.

Referring to FIG. 35, for example, the seventh guiding slope 241 may be an arc-shaped surface.

In other embodiments of the present disclosure, the difference from the above embodiments is that the guiding groove 244 is disposed on the connecting structure 200, and the guiding protrusion is disposed on the base 400. The relevant arrangement has been fully described in the above embodiments, and will not be described in detail here.

The background technology that may be applied to following embodiments is described herein. When the first limiting portion and the second limiting portion are locked with each other, the base 400 and the connecting structure 200 can be locked with each other. However, due to factors such as processing errors and assembly errors, etc., after the base 400 and the connecting structure 200 are locked with each other, there may be a certain gap between the base 400 and the connecting structure 200, causing the base 400 and the connecting structure 200 to shake relative to each other, and affecting the stability and the reliability of the connection. For example, when the base 400 is fixed on the fixed surface and the connecting structure 200 is connected to the output device, during use of the output device, the connecting structure 200 will shake relative to the base 400, affecting the stability of the connection and also aggravating the wear of the base 400 and the connecting structure 200.

Based on this, in an embodiment, a deformable second top block 250 and/or a deformable third top block is provided to fill the gap between the base 400 and the connecting structure 200.

In some embodiments, referring to FIG. 30, a deformable second top block 250 is disposed on a side of the connecting structure 200 facing the base 400. When the connecting structure 200 is locked with the base 400, the second top block 250 abuts against the base 400.

In the embodiment, the second top block 250 on the connecting structure 200 can abut against the base 400, so as to fill the gap between the base 400 and the connecting structure 200, which may help reduce shaking of the base 400 and the connecting structure 200, and may improve the stability of the connection between the base 400 and the connecting structure 200. By configuring the second top block 250 to be deformable, dimensional deviations caused by processing errors, assembly errors, etc., can be accommodated.

In some embodiments, the second top block 250 may be a rubber block.

In some embodiments, a deformable third top block is fixedly disposed on a side of the base 400 facing the connecting structure 200. When the connecting structure 200 is locked with the base 400, the third top block abuts against the connecting structure 200.

In the embodiment, the third top block on the base 400 can abut against the base 400, so as to fill the gap between the base 400 and the connecting structure 200, which may help reduce shaking of the base 400 and the connecting structure 200, and may improve the stability of the connection between the base 400 and the connecting structure 200. By configuring the third top block to be deformable, the dimensional deviations caused by the processing errors, the assembly errors, etc., can be accommodated.

In some embodiments, the third top block may be a rubber block.

In some possible embodiments, the third top block is disposed on the base 400, and the second top block 250 is disposed on the connecting structure 200.

In some embodiments, referring to FIG. 1 and FIG. 12, the output device may further include: a locking assembly, configured to lock the connecting structure 200; a first unlocking trigger apparatus or a first unlocking switch 511 (for example, a push switch), disposed on the motor 500 and communicatively connected to the locking assembly; and a second unlocking trigger apparatus or a second unlocking switch 6125 (for example, a push switch), disposed on the power supply assembly 600 and communicatively connected to the locking assembly. The locking assembly is configured to unlock the connecting structure 200 when both the first unlocking trigger apparatus 511 and the second unlocking trigger apparatus 6125 are triggered/actuated.

In the embodiment, by arranging the first unlocking trigger apparatus and the second unlocking trigger apparatus on the motor 500 and the power supply assembly 600 respectively, the connecting structure 200 can be unlocked when both the first unlocking trigger apparatus 511 and the second unlocking trigger apparatus 6125 are triggered. Thus, the user can be guided to hold the output device with both hands to detach the output device from the base 400, which may help reduce the possibility of accidental falling due to unstable holding when the output device is detached from the base 400, thereby improving user safety during use.

In some embodiments, referring to FIG. 10 to FIG. 12, the locking assembly may include: a locking member 300, movably disposed on the cable housing 100, and configured to abut against the connecting structure 200 to lock the connecting structure 200; and a driving apparatus, in transmission connection with the locking member 300, and connected to the first unlocking trigger apparatus 511 and the second unlocking trigger apparatus 6125. The driving apparatus is configured to drive the locking member 300 to move to unlock the connecting structure 200 when both the first unlocking trigger apparatus 511 and the second unlocking trigger apparatus 6125 are triggered.

In the embodiment, the locking member 300 is driven by the driving apparatus to be movable relative to the cable housing 100. For example, the locking member 300 may be slidably disposed on the cable housing 100, and an output shaft of the driving apparatus (for example, a motor) may be in driving connection with the locking member 300 via a gear-rack engagement. Thus, when the driving apparatus operates, the driving apparatus can drive the locking member 300 to slide relative to the cable housing 100.

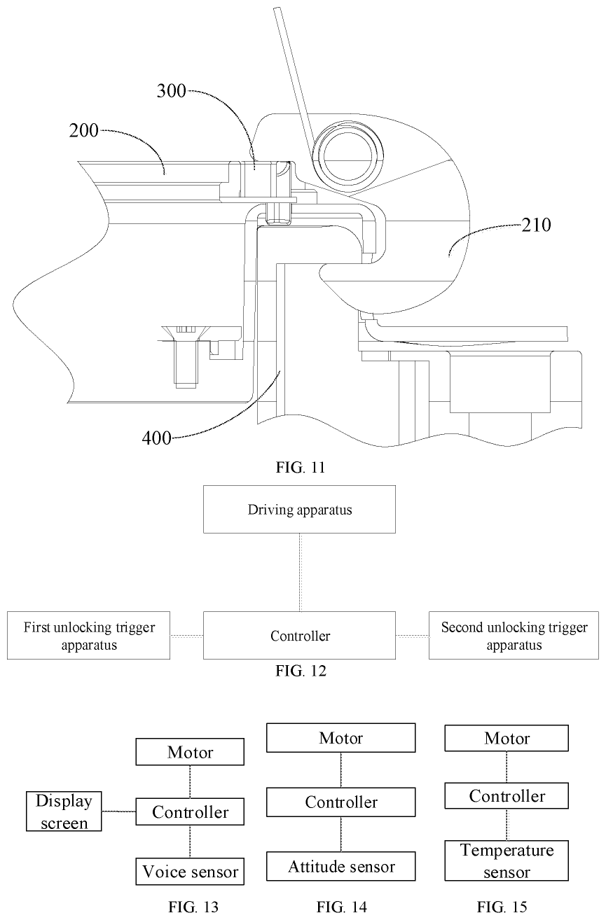

In some embodiments, referring to FIG. 10 and FIG. 11, the connecting structure 200 may include an engaging member 210 (for example, a hook) movably disposed on the cable housing 100. The engaging member 210 is engaged with the base 400 to fix the cable housing 100 to the base 400. When the engaging member 210 is engaged with the base 400, the locking member 300 can abut against the engaging member 210 to limit the movement of the engaging member 210. The driving apparatus is configured to drive the locking member 300 to move to release the abutment between the locking member 300 and the engaging member 210 when both the first unlocking trigger apparatus 511 and the second unlocking trigger apparatus 6125 are triggered.

In some embodiments, referring to FIG. 10 and FIG. 11, the engaging member 210 may be rotatably disposed on the cable housing 100. After the engaging member 210 is engaged with the base 400, the output device can be fixed on the base 400. Then, the locking member 300 can abut against the engaging member 210 to limit the engaging member 210 from rotating outward of the base 400 to disengage from the base 400, thereby locking the engaging member 210. When both the first unlocking trigger apparatus 511 and the second unlocking trigger apparatus 6125 are triggered, the driving apparatus can drive the locking member 300 to move, so that the locking member 300 and the engaging member 210 are released from abutment. The engaging member 210 can be rotated outward of the base 400 and disengage from the base 400, thus releasing the output device from the base 400.

In some embodiments, the power supply assembly 600 may include: the battery 610, fixed on the cable housing 100 and electrically connected to a printed circuit board (PCB) 740 on the cable housing 100; and a display screen 611, fixed on the cable housing 100 and electrically connected to the PCB 740.

In this solution, the battery 610 can supply power to the motor 500 and related components on the PCB 740. The display screen 611 can display working status information of the output device, which may facilitate user operation and use of the output device.

In some embodiments, the display screen 611 may be a touch screen, for example. A user can issue/send a control command by touching the display screen 611, and the output device may operate in response to the control command, which may make it more convenient for the user to operate and use the output device.

In some embodiments, the display screen 611 is located at a side of the battery 610.

In some embodiments, the display screen 611 may be located at a front side of the battery 610, so that the user can easily view the information displayed on the display screen 611.

In some embodiments, the power supply assembly 600 may further include a battery holder 619 fixedly connected to the cable housing 100. Both the battery 610 and the display screen 611 are fixedly connected to the battery holder 619. For example, the battery holder 619 may be fixed to the cable housing 100 via a screw.

In some embodiments, the second unlocking trigger apparatus 6125 may be disposed on the battery holder 619.

In another possible implementation, the second unlocking trigger apparatus 6125 may be disposed on the battery 610. A relief hole corresponding to the second unlocking trigger apparatus 6125 may be defined on the battery holder 619, which may allow the user to directly press or touch the second unlocking trigger apparatus 6125 through the relief hole.

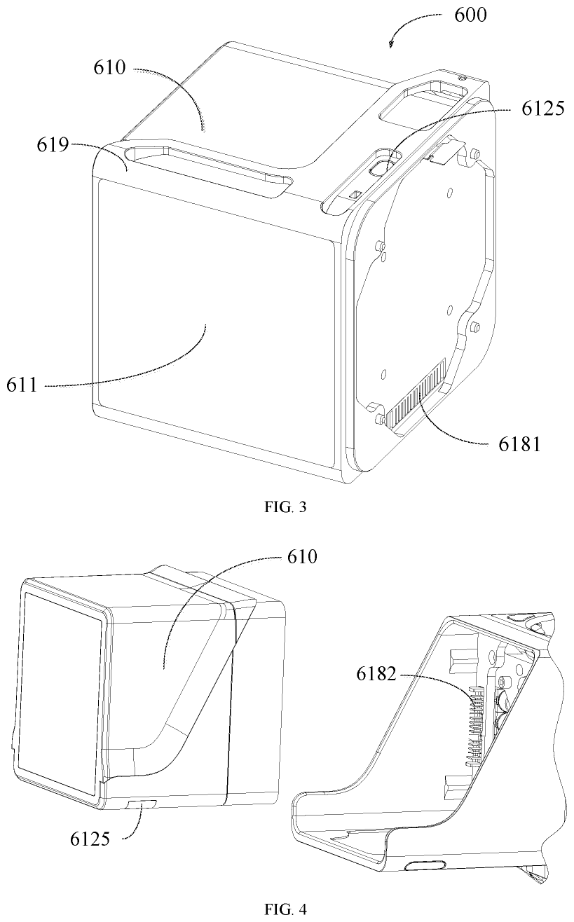

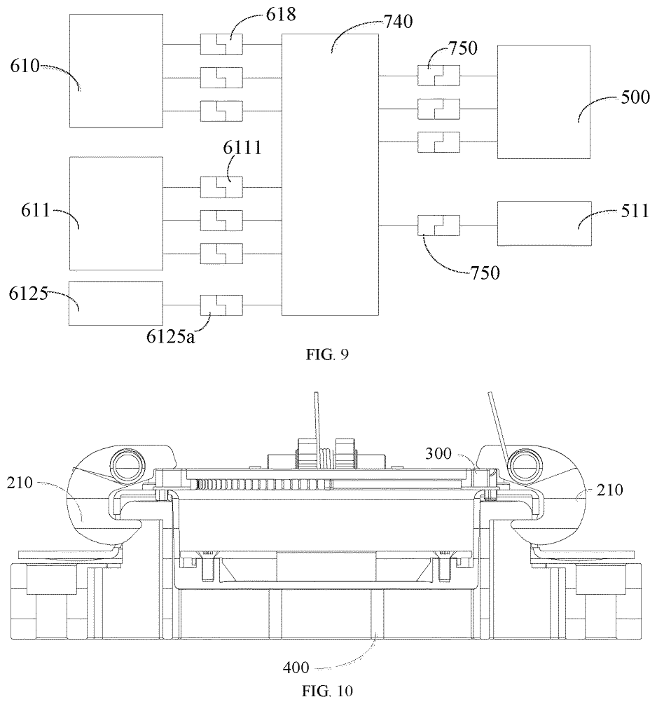

In some embodiments, referring to FIG. 3, FIG. 4, and FIG. 9, the battery 610 is electrically connected to the PCB 740 via a first quick-connect connector 618, thus facilitating quick disassembly of the battery 610.

In some embodiments, the first quick-connect connector 618 may include a first quick-connect sub-connector 6181 and a second quick-connect sub-connector 6182. The first quick-connect sub-connector 6181 is disposed on the battery 610, and the second quick-connect sub-connector 6182 is disposed on the PCB 740. When the battery 610 is mounted, the first quick-connect sub-connector 6181 is inserted into the second quick-connect sub-connector 6182, which may achieve electrical connection between the battery 610 and the PCB 740.

Referring to FIG. 9, the display screen 611 is electrically connected to the PCB 740 via a second quick-connect connector 6111. In this solution, by providing the second quick-connect connector 6111, the display screen 611 can be quickly disassembled.

In some embodiments, referring to FIGS. 7 to 9, the motor 500 is electrically connected to the PCB 740 on the cable housing 100 via a third quick-connect connector 750. In this solution, the third quick-connect connector 750 facilitates quick disassembly of the motor 500, which may make maintenance and repair more convenient.

In some embodiments, referring to FIGS. 7 to 9, the first unlocking trigger apparatus 511 is connected to the PCB 740 on the cable housing 100 via a fourth quick-connect connector 760.

In some embodiments, referring to FIG. 9, the second unlocking trigger apparatus 6125 is connected to the PCB 740 on the cable housing 100 via a fifth quick-connect connector 6125a.

In some embodiments, referring to FIG. 11, the output device may further include a voice sensor communicatively connected to a controller of the output device. The controller is configured to control the motor 500 to operate according to a voice command received by the voice sensor. In this solution, voice control of the output device can be achieved by providing the voice sensor.

Further, referring to FIG. 13, the controller may also be communicatively connected to the display screen 611, and the working status information of the output device (e.g., a current traction force, etc.) may be displayed via the display screen 611, which may facilitate the user to accurately operate the output device as needed.

In some embodiments, the controller is further configured to control the motor 500 to stop operation when the voice command received by the voice sensor exceeds a preset loudness. In this solution, when the user encounters an emergency, the user can stop the motor 500 by transmitting a sound exceeding the preset loudness, thereby improving safety of use.

In some embodiments, referring to FIG. 14, the output device may further include an attitude sensor communicatively connected to the controller of the output device. The controller is configured to determine current motion state information of the output device according to the attitude sensor, and control the motor 500 to operate according to the motion state information. The motion state information includes at least one of a current acceleration of the output device and a current angle of the output device.

In some embodiments, the attitude sensor may be a gyroscope, and the gyroscope may be a mechanical gyroscope or a Micro Electro Mechanical Systems (MEMS). It can be understood that the current acceleration of the output device can be determined by the gyroscope. By continuously tracking the current acceleration of the output device, a current state of the output device, the current angle of the output device, and whether the output device is oscillating, etc., can be determined, so that abnormalities can be discovered in time during the use of the output device, and corresponding measures can be taken.

In some embodiments, if the current acceleration of the output device exceeds a preset acceleration threshold, the output device may accidentally fall off, and the motor 500 can be controlled to stop operation at this time.

In some embodiments, referring to FIG. 15, the output device may further include a first temperature sensor configured to detect the temperature of the motor 500 and communicatively connected to the controller of the output device. The controller is configured to reduce an output power of the motor 500 when it is determined that the temperature of the motor 500 exceeds a preset first temperature threshold.

In this solution, when the temperature of the motor 500 exceeds the preset first temperature threshold, it can reduce the overheating of the motor 500 by reducing the output power of the motor 500. For example, when the temperature of the motor 500 is very high, the motor 500 can be controlled to stop operation immediately. When the temperature of the motor 500 is relatively high, the operation of the motor 500 can be appropriately reduced to decrease the temperature rise of the motor 500.

In some embodiments, the controller is further configured to control a prompt apparatus to issue prompt information when the temperature of the motor 500 exceeds a preset second temperature threshold. The second temperature threshold is less than the first temperature threshold.

In this solution, when the temperature of the motor 500 exceeds the preset second temperature threshold, the prompt apparatus is controlled to issue/send prompt information. The prompt information can be in various forms. For example, voice prompt information can be issued via a loudspeaker or a buzzer to prompt the user that the temperature of the motor 500 is relatively high. Alternatively, the motor 500 can be controlled to generate vibration to prompt the user. Alternatively, display information corresponding to relatively high temperature of the motor 500 can be displayed via the display screen 611. Of course, when the output device is wirelessly connected to a user terminal via Bluetooth or the like, the prompt information can also be pushed to the user terminal.

The prompt information may remind the user to use the motor 500 gently to reduce the temperature rise of the motor 500, or remind the user not to touch the motor 500 to prevent burns, etc., which is not limited herein.

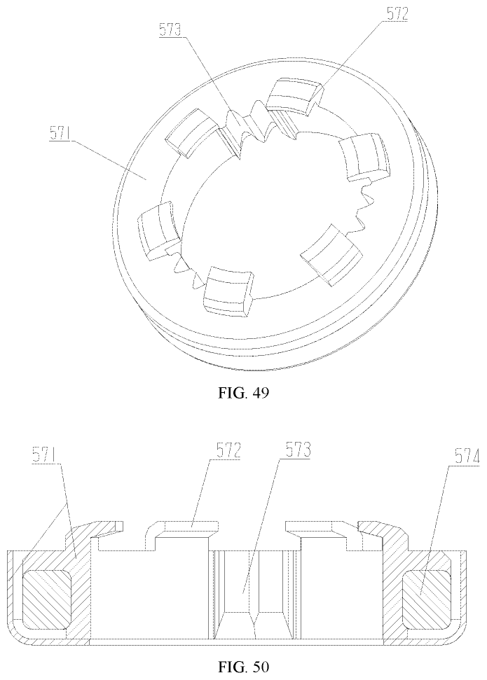

A connecting busbar 520 and the motor 500 provided in some embodiments are described below with reference to FIGS. 40-50.

An embodiment of a first aspect of the present disclosure provides the connecting busbar 520, and the connecting busbar 520 includes a mounting base 521 and a first connecting member 522 disposed on the mounting base 521. The mounting base 521 is an insulator, there is at least one first connecting member 522, the first connecting member 522 is inserted into the mounting base 521, and the first connecting member 522 includes at least two first connecting ends 5221 configured to be connected to the coil 550. In some embodiments, the mounting base 521 is an insulator, which can be formed by injection molding, can support the first connecting member 522, and play an isolating role to prevent the first connecting member 522 from being connected in series with other components. The first connecting member 522 is assembled to the mounting base 521 by plugging. The first connecting member 522 includes the at least two first connecting ends 5221. When the connecting busbar 520 is assembled to the motor 500, the first connecting end 5221 is configured to be connected to the coil 550 to achieve a connection function. The coil 550 connected to the first connecting end 5221 can be either a stator winding coil or a rotor winding coil. Compared with a traditional assembly method using a bolt connection, the first connecting member 522 is assembled to the mounting base 521 by plugging, which has a simple structure and is more convenient to assemble.

In some embodiments, the connecting busbar 520 includes a mounting base 521 and a second connecting member 523 disposed on the mounting base 521. The mounting base 521 is an insulator. There is at least one second connecting member 523, the second connecting member 523 is disposed in the mounting base 521, and the second connecting member 523 includes at least two second connecting ends 5231 configured to be connected to the coil 550. In some embodiments, the mounting base 521 is an insulator, which can be formed by injection molding, can support the second connecting member 523, and play an isolating role to prevent the second connecting member 523 from being connected in series with other components. The second connecting member 523 is disposed in the mounting base 521 by prefabrication or subsequent assembly. The second connecting member 523 is a conductor and includes the at least two second connecting ends 5231. When the connecting busbar 520 is assembled to the motor 500, the second connecting end 5231 is configured to be connected to the coil 550 to achieve a connection function. The coil 550 connected to the second connecting end 5231 can be either a stator winding coil 550 or a rotor winding coil 550.

In some embodiments, the connecting busbar 520 includes a mounting base 521, a first connecting member 522 and a second connecting member 523 disposed on the mounting base 521. The mounting base 521 is an insulator. There is at least one first connecting member 522, and the first connecting member 522 is inserted into the mounting base 521. The first connecting member 522 includes the at least two first connecting ends 5221 configured to be connected to the coil 550. There is at least one second connecting member 523, the second connecting member 523 is inserted into the mounting base 521, and the second connecting member 523 includes at least two second connecting ends 5231 configured to be connected to the coil 550. In some embodiments, the mounting base 521 is an insulator, which can be formed by injection molding, can support the first connecting member 522 and the second connecting member 523, and play an isolating role to prevent the first connecting member 522 and the second connecting member 523 from being connected in series with other components. The first connecting member 522 is assembled to the mounting base 521 by plugging, and the second connecting member 523 is disposed in the mounting base 521 by prefabrication or subsequent assembly. Both the first connecting member 522 and the second connecting member 523 are conductors. The first connecting member 522 includes the at least two first connecting ends 5221. The second connecting member 523 includes at least two second connecting ends 5231. When the connecting busbar 520 is assembled to the motor 500, both the first connecting end 5221 and the second connecting end 5231 are configured to be connected to the coil 550 to achieve a connection function. The coil 550 connected to the first connecting end 5221 and the second connecting end 5231 can be either the stator winding coil 550 or the rotor winding coil 550.

The connecting busbar 520 disclosed in some embodiments of the present disclosure provides positioning and fixation for the connecting member via the mounting base 521, which may help reduce irregular wiring between coils 550. The use of the mounting base 521 simplifies installation of the connecting busbar 520. The second connecting member 523 pre-installed inside the mounting base 521 can be directly connected to the corresponding coil 550 during installation. The first connecting member 522 inserted into the mounting base 521 can first assemble the mounting base 521 to the motor 500, and the first connecting member 522 is inserted into the mounting base 521 and connect the corresponding coil 550. The first connecting member 522 can also be combined with the mounting base 521 and then assembled into the motor 500 together to achieve the connection between the first connecting member 522 and the mounting base 521.

Referring to FIG. 45, in some embodiments, two adjacent coils 550 that are relatively spaced close to each other can be connected to each other via the first connecting member 522. At this time, the two first connecting ends 5221 of the first connecting member 522 are relatively spaced close to each other, so that a volume of the first connecting member 522 is small, which may ensure a strength of the first connecting member 522 during plugging and assembly. In some embodiments, two adjacent coils 550 that are spaced apart from each other can be connected to each other via the second connecting member 523. At this time, the second connecting ends 5231 of the second connecting member 523 are spaced apart from each other, and the second connecting member 523 is disposed in the mounting base 521, which can help support the strength and can be designed to be larger, and is suitable for connecting non-adjacent coils 550 or spaced-apart coils 550 that need to be connected. It should be noted that the first connecting member 522 and the second connecting member 523 can be used separately or simultaneously. The above-mentioned first connecting member 522 is configured to connect adjacent coils 550, and the second connecting member 523 is configured to be connected to the spaced-apart coils 550, which is merely an exemplary embodiment. In some embodiments, the first connecting member 522 is configured to be connected to the spaced-apart coils 550, and the second connecting member 523 is configured to be connected to two adjacent coils 550.

Referring to FIGS. 40-41, in some embodiments, the mounting base 521 simultaneously includes both the first connecting member 522 and the second connecting member 523. The first connecting ends 5221 of the first connecting member 522 are spaced close to each other and can connect two adjacent coils 550. The second connecting ends 5231 of the second connecting member 523 are spaced apart from each other and can connect the spaced-apart coils 550. The two adjacent coils 550 are connected to each other via the first connecting member 522, and the spaced-apart coils 550 are connected to each other via the second connecting member 523, which may allow adjustment according to connection requirements of the coils 550, and enable flexible use of the first connecting member 522 and the second connecting member 523 to connect the coils 550.

In some embodiments, at least one insertion slot 5211 is defined on the mounting base 521 and is inserted into the first connecting member 522. The first connecting member 522 further includes an insertion portion 5222, and the insertion portion 5222 is configured to be inserted into the insertion slot 5211. In some embodiments, the mounting base 521 is annular, and insertion slots 5211 are defined on an inner side of the mounting base 521, an outer side of the mounting base 521, or both the inner side and the outer side of the mounting base 521. The number of insertion slots 5211 can correspond to the number of the first connecting members 522. After the insertion portion 5222 of the first connecting member 522 is inserted into the insertion slot 5211, the first connecting end 5221 is ensured to be exposed on the inner side or the outer side of the mounting base 521. At this time, after the connecting busbar 520 is assembled to the motor 500, the first connecting end 5221 can be connected to the coil 550. Of course, the mounting base 521 can also be assembled to the motor 500 first, and then the first connecting member 522 can be inserted.

Referring to FIG. 40, in some embodiments, a third protruding portion 5213 is provided on a side wall of the mounting base 521, and the insertion slot 5211 is defined on the third protruding portion 5213. The insertion slot 5211 is defined by defining a vertical slot downward from an upper end of the third protruding portion 5213, which may ensure that after the insertion portion 5222 of the first connecting member 522 is inserted into the insertion slot 5211, the first connecting end 5221 is exposed on the inner side or the outer side of the mounting base 521, which may facilitate subsequent connection with the coil 550.

Referring to FIG. 42, in some embodiments, each first connecting member 522 includes the insertion portion 5222 and two first connecting ends 5221. The insertion portion 5222 is connected to the two first connecting ends 5221, and the two first connecting ends 5221 are located on both sides of the insertion portion 5222. A middle part of the first connecting member 522 is the insertion portion 5222, and parts of the first connecting member 522 extending from both sides are the first connecting ends 5221. The corresponding insertion slot 5211 can be defined on the third protruding portion 5213 protruding from the side wall of the mounting base 521. The insertion slot 5211 is defined vertically on an upper side of the third protruding portion 5213. After the insertion portion 5222 is inserted into the insertion slot 5211, the two first connecting ends 5221 are on the outside, which can be conveniently connected to the coil 550.

Referring to FIG. 43, in other embodiments, each first connecting member 522 includes two insertion portions 5222 and two first connecting ends 5221. The two first connecting ends 5221 are connected to each other. The two insertion portions 5222 are located on both sides of the first connecting ends 5221. The insertion portion 5222 and the first connecting end 5221 are arranged at an angle. The two first connecting ends 5221 are connected by a long strip-shaped first connecting portion 5223, and are connected to a side of the first connecting portion 5223. Alternatively, the two first connecting ends 5221 and the first connecting portion 5223 are an integral structure. Two ends of the first connecting portion 5223 are connected to the insertion portions 5222. Alternatively, the two ends of the first connecting portion 5223 are bent to form the insertion portions 5222. The insertion portions 5222 and the first connecting end 5221 are arranged at the angle, which may make the connection between the first connecting member 522 and the insertion slot 5211 more stable.

In some embodiments, the angle between the insertion portion 5222 and the first connecting end 5221 is less than 90 degrees. That is, ends of the two insertion portions 5222 at both ends should face each other, which may further improve the stability of the plug-in connection. Meanwhile, a size of the first connecting member 522 can be minimized, so that the mounting base 521 can stack more first connecting members 522.

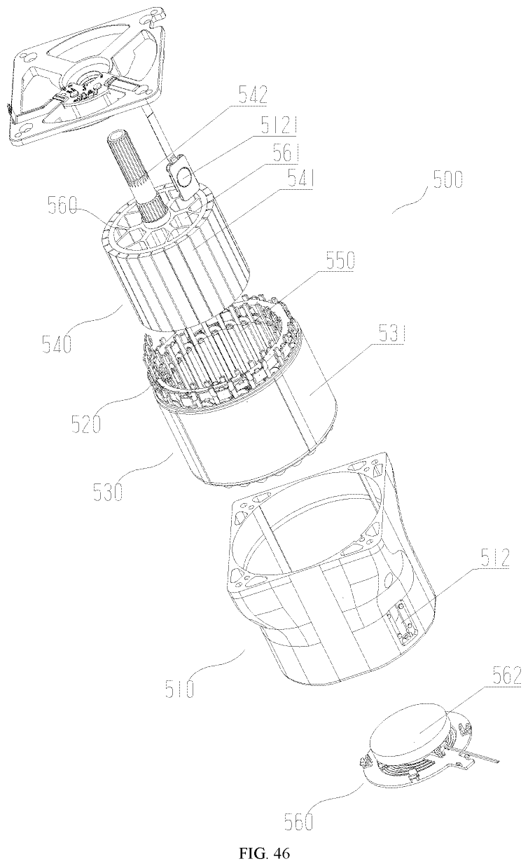

Referring to FIG. 40, FIG. 41, FIG. 45, and FIG. 46, in some embodiments, the mounting base 521 is annular to accommodate a rotating body of the motor 500. The coil 550 of the motor 500 is arranged peripherally, and the annular mounting base 521 can also simplify installation.

As shown in FIG. 41, in some embodiments, an annular groove 5212 is defined on the mounting base 521. The second connecting member 523 is mounted in the annular groove 5212, and the second connecting end 5231 extends out of the annular groove 5212. In this subsequent installation method, when manufacturing the mounting base 521, the annular groove 5212 is pre-formed on a top surface of the mounting base 521, which may leave an opening for the second connecting end 5231 to extend out. The second connecting member 523 is then mounted in the annular groove 5212, and the second connecting end 5231 extends out of the annular groove 5212 via the opening.

Further, the connecting busbar 520 also includes a connecting cover plate 524. The connecting cover plate 524 is combined with the annular groove 5212 to fix the second connecting member 523, so that installation of the second connecting member 523 is more stable.

In some embodiments, there are a plurality of second connecting members 523. When the plurality of second connecting members 523 are mounted in the annular groove 5212, adjacent two of the second connecting members 523 are isolated by an insulating pad 525. In this method of assembling the second connecting members 523 to the mounting base 521, to facilitate processing and assembly, the annular groove 5212 is not designed with a structure to isolate adjacent connecting busbars 520. Therefore, when mounting the second connecting members 523, an insulating pad 525 is mounted between the adjacent two of the second connecting members 523 for isolation, which may reduce an occurrence of direct connection of the second connecting members 523.

Referring to FIG. 40, in other embodiments, the second connecting member 523 is embedded in the mounting base 521, and the second connecting end 5231 extends out from the mounting base 521. In this manner, the second connecting member 523 and the mounting base 521 are pre-formed and do not need subsequent assembly, which may greatly simplify assembly process.

In some embodiments, the second connecting member 523 and the mounting base 521 are pre-formed by injection molding. The second connecting member 523 further includes a positioning portion 5233. The positioning portion 5233 extends out from the mounting base 521 after molding, and the positioning portion 5233 is configured to position the second connecting member 523 during injection molding.

Referring to FIG. 44, regardless of subsequent installation or prefabrication, the second connecting member 523 includes a second connecting portion 5232. The second connecting end 5231 extends from or is connected to a side of the second connecting portion 5232 to form an angle. In the pre-forming method, a positioning portion 5233 also extends from or is connected to the side of the second connecting portion 5232. During injection molding, the second connecting member 523 is positioned in a mold via the positioning portion 5233, and it may be useful to help support that the plurality of second connecting members 523 do not contact each other. Thus, the mounting base 521 with an embedded second connecting member 523 can be obtained through injection molding.

An embodiment of a second aspect of the present disclosure provides the motor 500. As shown in FIG. 46, the motor 500 includes a motor housing 510, a stator assembly 530, and a rotor assembly 540. The stator assembly 530 is fixedly disposed in the motor housing 510, and the rotor assembly 540 is rotatably disposed in the motor housing 510. The stator assembly 530 and/or the rotor assembly 540 includes the coil 550 and the connecting busbar 520 according to any one of the embodiments of the first aspect. All or part of the coil 550 is connected to the first connecting end 5221 or the second connecting end 5231 of the connecting busbar 520. By using the connecting busbar 520, the motor 500 is more concise in design, easier to assemble, and more stable.

In some embodiments, the stator assembly 530 of the motor 500 includes the coil 550, and the connecting busbar 520 includes the mounting base 521, and the first connecting member 522 and the second connecting member 523 disposed on the mounting base 521. The first connecting ends 5221 of the first connecting member 522 are spaced close to each other and can connect two adjacent coils 550. The second connecting ends 5231 of the second connecting member 523 are spaced apart from each other and can connect the spaced-apart coils 550. When the stator assembly 530 is assembled, the first connecting ends 5221 of the first connecting member 522 are connected to two adjacent coils 550, and the second connecting end 5231 of the second connecting member 523 is connected to the spaced-apart coils 550, working together to power the coil 550. Of course, the motor 500 may be configured such that the coil 550 is provided on the rotor assembly 540.

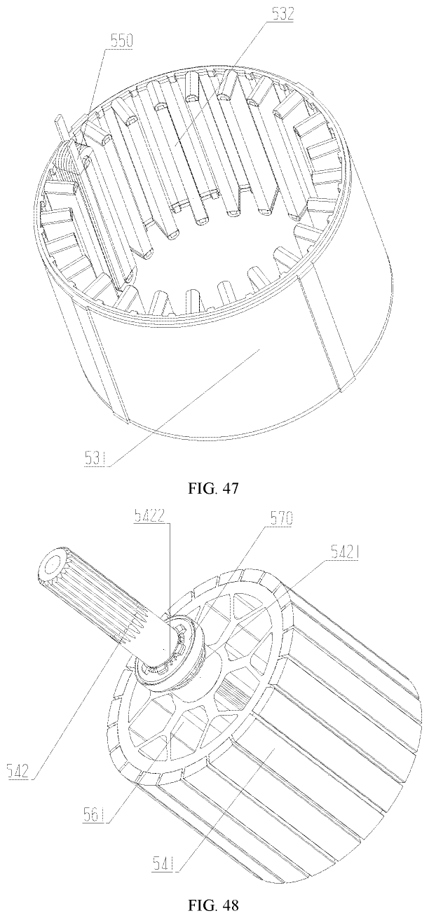

Further, the motor 500 also includes an iron core, and the iron core is annular. A plurality of winding frames or bobbins 532 are provided in the iron core. A flat wire is wound on/around the winding frame 532 to form the coil 550, that is, the coil 550 may include the flat wire wound on/around the winding frame 532. The coil 550 is wound with the flat wire, which has a smaller volume, less material and lower cost at the same power. A contact area between flat wires is large, and heat dissipation and heat conduction are better, which is beneficial to improving the heat dissipation effect of the motor 500. Moreover, a terminal of the coil 550 wound by the flat wires is sheet-shaped, and the first connecting end 5221 of the first connecting member 522 and the second connecting end 5231 of the second connecting member 523 are also in sheet shape, which can better and more conveniently achieve the connection between a first terminal, a second terminal and the coil 550. Referring to FIG. 47, in some embodiments, the stator assembly 530 employs a winding method. The stator core 531 is annular, and the plurality of winding frames 532 are peripherally arranged inside the stator core. The flat wire is wound on the winding frames 532.

The heat dissipation effect has a great influence on performance of the motor 500. When the motor 500 is configured for use in equipment that needs to repeatedly rotate forward and reverse, such as a cable output device, higher heat dissipation requirements are imposed. In some embodiments, the motor 500 further includes a heat dissipation fan 730. The rotor assembly 540 and/or the stator assembly 530 includes an avoidance portion configured to mount the heat dissipation fan 730. The heat dissipation fan 730 is mounted in the avoidance portion and accelerates air flow by rotating, which may enhance the heat dissipation effect of the motor 500.

As shown in FIG. 46 and FIG. 48, in some embodiments, the heat dissipation fan 730 is a passive fan, and the heat dissipation fan 730 is disposed in the avoidance portion of the rotor assembly 540. For example, the rotor core 541 of the rotor assembly 540 is annular, and the heat dissipation fan 730 is fixedly disposed in an annular structure. When a rotor rotates, the heat dissipation fan 730 can be driven to rotate synchronously, which may effectively improve heat dissipation capacity of the motor 500.

However, when the motor 500 needs to frequently rotate forward and reverse or operates at a low speed, the above-mentioned heat dissipation method using the passive fan exhibits a problem of unstable heat dissipation capacity, which is greatly affected by the forward and reverse rotation and the rotational speed of the motor 500. This imposes certain limitations on improving the heat dissipation capacity of the motor 500 and cannot help support that the motor 500 operates at an appropriate operating temperature. Based on this, referring to FIG. 46, in other embodiments, the heat dissipation fan 730 is an active fan 562. The heat dissipation fan 730 is connected to the stator assembly 530 or the motor housing 510, and rotates independently relative to the rotor assembly 540. For example, the iron core of the rotor assembly 540 is annular, and the heat dissipation fan 730 is located in the annular structure but does not contact the iron core. Alternatively, there is a gap between an end portion of the stator assembly 530 and the motor housing 510, and the heat dissipation fan 730 is located in the gap. This design of using the active fan 562 for heat dissipation is not affected by the forward and reverse rotation and the rotational speed of the motor 500, which can maintain stable heat dissipation capacity, which may help support that the motor 500 operates at an appropriate operating temperature.

In some embodiments, the active fan 562 is integrated with a driving apparatus and connected to a wiring board of the motor 500 via a third FPC flexible cable. The third FPC flexible cable has a certain flexibility and can be arranged arbitrarily according to spatial layout, which may simplify wiring, and make internal layout of the motor 500 more compact and the motor 500 more miniaturized. The third FPC flexible cable is located on the outside of the stator assembly 530, and a metal protective plate is provided on a side of the third FPC flexible cable facing the rotor assembly 540 or the stator assembly 530, so that the third FPC flexible cable can be bent into a required shape through the metal protective plate, which may facilitate routing. The metal protective plate can also protect the third FPC flexible cable, and also isolate magnetic field, which may reduce adverse effects of the magnetic field.

Referring to FIGS. 8-50, in some embodiments, a magnetic ring 570 is further included. The magnetic ring 570 is disposed on a rotor shaft 542 of the rotor assembly 540. The magnetic ring 570 can be connected to the rotor shaft 542 by bonding, which is convenient to use. The magnetic ring 570 and the rotor shaft 542 can also be connected by structural cooperation, such as axial positioning via a magnetic ring buckle 572 and peripheral positioning via the spline 573, instead of gluing, to reduce excessive glue filling and overflow, or insufficient glue filling and unstable connection. In some embodiments, an inner ring of the magnetic ring 570 includes the spline 573. The spline 573 can be a continuous ring of tooth structure or discontinuous, separate segments of tooth structure. A side of the magnetic ring 570 includes the magnetic ring buckle 572, and a keyway 5421 and a groove 5422 are defined on the corresponding rotor shaft 542. When the magnetic ring 570 is mounted on the rotor shaft 542, the spline 573 cooperates with the keyway 5421, and the magnetic ring buckle 572 is inserted into the groove 5422.

Further, the magnetic ring 570 includes a shell 571 and a magnetic component 574 embedded in the shell 571. When connected to the rotor shaft 542 by structural cooperation, structures such as the magnetic ring buckle 572 and the spline 573 provided on the magnetic ring 570 for connection are all disposed on the shell 571.

In some embodiments, the shell 571 is injection-molded outside the magnetic component 574. In this way, the magnetic component 574 is magnetized after injection molding and cooling, which may help reduce high temperature during injection molding from affecting magnetism of the magnetic component 574.

Referring to FIG. 50, in other embodiments, the shell 571 is provided in a split manner, and the shell 571 is assembled outside the magnetic component 574. The separately produced shell 571 includes at least two parts, which are connected into a whole via a magnetic ring buckle 572 or an interference fit. In addition, a cavity is defined inside the separately produced shell 571, and the magnetic component 574 is mounted in the cavity.

In some embodiments, the motor housing 510 further includes a motor key mounting position 512 configured to mount a second functional key 5121, and the second functional key 5121 is connected to the wiring board of the motor 500 via the third FPC flexible cable. The second functional key 5121 can be a key related to a function of the motor 500, such as a switch of the motor 500, or a control switch of the active fan 562. The second functional key 5121 can also be a key related to a function of a device where the motor 500 is located. Especially when there is no location for configuring a key on the device, the key can be configured on the motor 500, which may provide more sufficient installation space.

In some embodiments, two second functional keys 5121 may be provided to control a locking assembly of the connecting structure 200. Pressing the two second functional keys 5121 at the same time can unlock the locking assembly, so that the output device can be removed from the base 400.

In some embodiments, the first functional key 6124 and the second functional key 5121 can be arranged at the same time. Pressing the two second functional keys 5121 at the same time can unlock the locking assembly, so that the output device can be removed from the base 400. At this time, both hands are respectively located on the battery 610 and the motor 500, so that gripping the output device is more stable.

In some embodiments, an angle sensor and/or a revolution sensor can be disposed on a motor shaft, a reel shaft, or any transmission shaft, and configured to record a rotation angle and/or the number of revolutions of the corresponding transmission shaft, and further calculate how long the cable 900 of the current output device has been pulled out based on a transmission ratio between the transmission shaft and the reel shaft, and a periphery of the reel shaft.

In some embodiments, one or more of the technical solutions of the universal cable outlet assembly 120, the technical solution of the winding reel 130 to fix the cable 900, the solution of arranging the cable on the winding reel 130 via the cable-arranging assembly 140, the solution of coupling the connecting structure 200 with the base 400, the solution of the connecting busbar 520 in the motor 500, and the solution of the battery 610 can be applied not only to the output device but also to the corresponding structures of other fitness equipment.

According to a first aspect of the present disclosure, the connecting busbar according to some embodiments of the present disclosure is configured in a motor. The motor includes a plurality of coils arranged in a peripheral direction. The connecting busbar includes: a mounting base, where the mounting base is an insulating member; at least one first connecting member, inserted into the mounting base, where the first connecting member includes at least two first connecting ends, and a corresponding one of the at least two first connecting ends is configured to connect to a corresponding one of the plurality of coils; and at least one second connecting member, disposed on the mounting base, and including at least two second connecting ends, and a corresponding one of the at least two second connecting ends is configured to be connected to another corresponding one of the plurality of coils.

In some embodiments, at least one of the following is satisfied: the at least two first connecting ends are spaced close to each other and are configured to be connected to two adjacent coils of the plurality of coils; or, the at least two second connecting ends are arranged spaced apart each other and are configured to be connected to two spaced-apart coils of the plurality of coils.

In some embodiments, the second connecting member and the mounting base are pre-formed by injection molding; the second connecting member further includes a positioning portion, the positioning portion extends out from the mounting base, and the positioning portion is configured to position the second connecting member during injection molding.

According to a second aspect of the present disclosure, the connecting busbar according to some embodiments of the present disclosure is configured in a motor. The motor includes a plurality of coils arranged in a peripheral direction. The connecting busbar includes: a mounting base, where the mounting base is an annular insulating member; a first connecting member, including two first connecting ends disposed at intervals along the peripheral direction, where the first connecting member is disposed on at least one of an inner side of the mounting base or an outer side of the mounting base, and the first connecting member is connected to two adjacent coils of the plurality of coils via the two first connecting ends; and a second connecting member, including two second connecting ends and a second connecting portion connected to the two second connecting ends, where the two second connecting ends are disposed at intervals along the peripheral direction, the second connecting portion extends along a top surface of the mounting base, and the second connecting member is connected to two spaced-apart coils of the plurality of coils via the two second connecting ends.

In some embodiments, the first connecting member is assembled to the mounting base in an inserting manner.

In some embodiments, at least one insertion slot is defined on the mounting base, the first connecting member further includes an insertion portion, and the insertion portion is configured to be inserted into the at least one insertion slot; and the two first connecting ends are exposed at an inner side or an outer side of the mounting base.

In some embodiments, a protruding portion is disposed on at least one of the inner side or the outer side of the mounting base, and the at least one insertion slot is defined on the protruding portion, and the at least one insertion slot is vertically defined downward from an upper end of the protruding portion.

In some embodiments, the insertion portion is connected to the two first connecting ends, and the two first connecting ends are located on both sides of the insertion portion, respectively.

In some embodiments, the first connecting member includes a first connecting portion and two insertion portions, the two first connecting ends are connected to each other by the first connecting portion, the two insertion portions are located on both sides of the two first connecting ends, and a corresponding one of the two insertion portions and a corresponding one of the two first connecting ends are arranged at an angle; the angle between the corresponding one of the two insertion portions and the corresponding one of the two first connecting ends is less than 90 degrees.

In some embodiments, each of the plurality of coils includes two terminals, one of the two terminals is disposed at the inner side of the mounting base, and the other of the two terminals is disposed at the outer side of the mounting base; and there are a plurality of first connecting members, and the plurality of first connecting members includes two groups of first connecting members, one group of the first connecting members is disposed at the inner side of the mounting base, the other group of the first connecting members is disposed at the outer side of the mounting base, and a corresponding one of the plurality of first connecting members disposed at the inner side and a corresponding one of the plurality of first connecting members disposed at the outer side are arranged in a staggered manner along the peripheral direction.

In some embodiments, the second connecting member is arranged inside the mounting base by prefabrication or subsequent assembly, and the two second connecting ends extend out of the mounting base.

In some embodiments, an annular groove is defined on the mounting base, the second connecting member is mounted in the annular groove, and the second connecting end extends out of the annular groove.

In some embodiments, the connecting busbar further includes a cover plate, and the cover plate is configured to cover the annular groove; there are a plurality of second connecting members, the plurality of second connecting members are disposed in the annular groove, the connecting busbar further includes an insulating pad, and two adjacent second connecting members of the plurality of second connecting members are isolated from each other by the insulating pad.

In some embodiments, the second connecting member and the mounting base are pre-formed, and the second connecting member is embedded in the mounting base; the second connecting member further includes a positioning portion connected to the second connecting portion, the positioning portion extends out from the mounting base.

In some embodiments, a corresponding one of the plurality of coils includes a wound flat wire, a terminal of the corresponding one of the plurality of coils is sheet-shaped, and a corresponding one of the two first connecting ends and a corresponding one of the two second connecting ends are sheet-shaped; and the terminal of the corresponding one of the plurality of coils, the corresponding one of the two first connecting ends, and the corresponding one of the two second connecting ends are stacked along a thickness direction.

In some embodiments, the terminal of each of the plurality of coils, each of the two first connecting ends, and each of the two second connecting ends protrude from the top surface of the mounting base.

In some embodiments, the second connecting member is embedded in the mounting base, and the second connecting end extends out from the mounting base.

According to a third aspect of the present disclosure, the motor according to some embodiments of the present disclosure includes: a motor housing; a stator assembly, fixedly disposed in the motor housing; a rotor assembly, rotatably disposed in the motor housing; and a plurality of coils, arranged in a peripheral direction; and a connecting busbar, including: a mounting base, where the mounting base is an insulating member; at least one first connecting member, inserted into the mounting base, where the first connecting member includes at least two first connecting ends, where a corresponding one of the at least two first connecting ends is configured to be connected to a corresponding one of the plurality of coils; and at least one second connecting member, disposed on the mounting base, and including at least two second connecting ends, where a corresponding one of the at least two second connecting ends is configured to be connected to another corresponding one of the plurality of coils; where the plurality of coils and the connecting busbar are located on the stator assembly or on the rotor assembly.

In some embodiments, the motor is configured in a cable output device; the stator assembly includes a stator core, a plurality of winding frames are arranged inside the stator core along a peripheral direction of the stator core, and a corresponding one of the plurality of coils includes a flat wire wound around a corresponding one of the plurality of winding frames; and the corresponding one of the plurality of coils includes the flat wire stacked along a thickness direction, and a stacking direction extends toward a central axis of the stator core.

In some embodiments, the motor further includes a heat dissipation fan, and at least one of the rotor assembly or the stator assembly includes an avoidance portion, and the avoidance portion is configured to mount the heat dissipation fan.

In some embodiments, the stator assembly is sleeved on the rotor assembly; where a core of the rotor assembly is annular, and the heat dissipation fan is disposed inside an annular structure of the rotor assembly; or a gap is defined between an end portion of the stator assembly and the motor housing, and the heat dissipation fan is located in the gap.

In some embodiments, the heat dissipation fan is a passive fan, and the heat dissipation fan is disposed in the avoidance portion of the rotor assembly; or the heat dissipation fan is an active fan, the heat dissipation fan is connected to the stator assembly or the motor housing, the heat dissipation fan is located in the avoidance portion of at least one of the stator assembly or the rotor assembly, and the heat dissipation fan rotates independently relative to the rotor assembly.

In some embodiments, the active fan is integrated with a driving apparatus and connected to a motor terminal board via a third FPC flexible cable; the third FPC flexible cable is located on the outer side of the stator assembly; and a metal protective plate is provided on a side of the third FPC flexible cable facing the rotor assembly or the stator assembly.

In some embodiments, the motor further includes: a magnetic ring, disposed on a rotor shaft of the rotor assembly, and connected to the rotor shaft by bonding, or at least one of the following is satisfied: the magnetic ring and the rotor shaft are axially positioned via a magnetic ring snap, or the magnetic ring and the rotor shaft are peripherally positioned via a spline.

In some embodiments, the magnetic ring includes a shell and a magnetic component embedded in the shell, and the magnetic ring snap and the spline are both provided on the shell; the shell is injection-molded outside the magnetic component, or the shell is provided in a split manner and assembled outside the magnetic component; when the shell is injection-molded outside the magnetic component, the magnetic component is magnetized after injection molding and cooling.

In some embodiments, a motor key mounting position is further arranged on the motor housing and configured to mount a second functional key, and the second functional key is connected to a motor terminal board via the third FPC flexible cable.

The description with reference to terms such as “an embodiment”, “some embodiments”, “specifically”, or “some examples” means that a specific feature, structure, material, or characteristic described in conjunction with the embodiment or example is included in at least one embodiment or example of the present disclosure. In this specification, the exemplary expressions of the above terms do not necessarily refer to the same embodiment or example. Moreover, the described specific features, structures, materials, or characteristics may be combined in any one or more embodiments or examples in a suitable manner.

Although the embodiments of the present disclosure have been shown and described, those having ordinary skill in the art can understand that various changes, modifications, substitutions, and variations may be made to the embodiments without departing from the principle and spirit of the present disclosure, and the scope of the present disclosure is defined by the claims and their equivalents.

1. A connecting busbar, configured in a motor, wherein the motor comprises a plurality of coils arranged in a peripheral direction, and the connecting busbar comprises:
a mounting base, wherein the mounting base is an insulating member;
at least one first connecting member, inserted into the mounting base, wherein the first connecting member comprises at least two first connecting ends, and a corresponding one of the at least two first connecting ends is configured to connect to a corresponding one of the plurality of coils; and
at least one second connecting member, disposed on the mounting base, and comprising at least two second connecting ends, and a corresponding one of the at least two second connecting ends is configured to be connected to another corresponding one of the plurality of coils.

2. The connecting busbar according to claim 1, wherein at least one of the following is satisfied:
the at least two first connecting ends are spaced close to each other and are configured to be connected to two adjacent coils of the plurality of coils; or,
the at least two second connecting ends are arranged spaced apart each other and are configured to be connected to two spaced-apart coils of the plurality of coils.

3. The connecting busbar according to claim 1, wherein the second connecting member and the mounting base are pre-formed by injection molding;
the second connecting member further comprises a positioning portion, the positioning portion extends out from the mounting base, and the positioning portion is configured to position the second connecting member during injection molding.

4. A connecting busbar, configured in a motor, wherein the motor comprises a plurality of coils arranged in a peripheral direction, and the connecting busbar comprises:
a mounting base, wherein the mounting base is an annular insulating member;
a first connecting member, comprising two first connecting ends disposed at intervals along the peripheral direction, wherein the first connecting member is disposed on at least one of an inner side of the mounting base or an outer side of the mounting base, and the first connecting member is connected to two adjacent coils of the plurality of coils via the two first connecting ends; and
a second connecting member, comprising two second connecting ends and a second connecting portion connected to the two second connecting ends, wherein the two second connecting ends are disposed at intervals along the peripheral direction, the second connecting portion extends along a top surface of the mounting base, and the second connecting member is connected to two spaced-apart coils of the plurality of coils via the two second connecting ends.

5. The connecting busbar according to claim 4, wherein the first connecting member is assembled to the mounting base in an inserting manner.

6. The connecting busbar according to claim 4, wherein at least one insertion slot is defined on the mounting base, the first connecting member further comprises an insertion portion, and the insertion portion is configured to be inserted into the at least one insertion slot; and
the two first connecting ends are exposed at an inner side or an outer side of the mounting base.

7. The connecting busbar according to claim 6, wherein a protruding portion is disposed on at least one of the inner side or the outer side of the mounting base, and the at least one insertion slot is defined on the protruding portion, and the at least one insertion slot is vertically defined downward from an upper end of the protruding portion.

8. The connecting busbar according to claim 6, wherein the insertion portion is connected to the two first connecting ends, and the two first connecting ends are located on both sides of the insertion portion, respectively.

9. The connecting busbar according to claim 6, wherein the first connecting member comprises a first connecting portion and two insertion portions, the two first connecting ends are connected to each other by the first connecting portion, the two insertion portions are located on both sides of the two first connecting ends, and a corresponding one of the two insertion portions and a corresponding one of the two first connecting ends are arranged at an angle;
the angle between the corresponding one of the two insertion portions and the corresponding one of the two first connecting ends is less than 90 degrees.

10. The connecting busbar according to claim 4, wherein each of the plurality of coils comprises two terminals, one of the two terminals is disposed at the inner side of the mounting base, and the other of the two terminals is disposed at the outer side of the mounting base; and
there are a plurality of first connecting members, and the plurality of first connecting members comprises two groups of first connecting members, one group of the first connecting members is disposed at the inner side of the mounting base, the other group of the first connecting members is disposed at the outer side of the mounting base, and a corresponding one of the plurality of first connecting members disposed at the inner side and a corresponding one of the plurality of first connecting members disposed at the outer side are arranged in a staggered manner along the peripheral direction.

11. The connecting busbar according to claim 4, wherein the second connecting member is arranged inside the mounting base by prefabrication or subsequent assembly, and the two second connecting ends extend out of the mounting base.

12. The connecting busbar according to claim 11, wherein
an annular groove is defined on the mounting base, the second connecting member is mounted in the annular groove, and the second connecting end extends out of the annular groove.

13. The connecting busbar according to claim 12, wherein the connecting busbar further comprises a cover plate, and the cover plate is configured to cover the annular groove;
there are a plurality of second connecting members, the plurality of second connecting members are disposed in the annular groove, the connecting busbar further comprises an insulating pad, and two adjacent second connecting members of the plurality of second connecting members are isolated from each other by the insulating pad.

14. The connecting busbar according to claim 4, wherein the second connecting member and the mounting base are pre-formed, and the second connecting member is embedded in the mounting base;
the second connecting member further comprises a positioning portion connected to the second connecting portion, the positioning portion extends out from the mounting base.

15. The connecting busbar according to claim 4, wherein a corresponding one of the plurality of coils comprises a wound flat wire, a terminal of the corresponding one of the plurality of coils is sheet-shaped, and a corresponding one of the two first connecting ends and a corresponding one of the two second connecting ends are sheet-shaped; and
the terminal of the corresponding one of the plurality of coils, the corresponding one of the two first connecting ends, and the corresponding one of the two second connecting ends are stacked along a thickness direction.

16. The connecting busbar according to claim 4, wherein the terminal of each of the plurality of coils, each of the two first connecting ends, and each of the two second connecting ends protrude from the top surface of the mounting base.

17. A motor, comprising:
a motor housing;
a stator assembly, fixedly disposed in the motor housing;
a rotor assembly, rotatably disposed in the motor housing; and
a plurality of coils, arranged in a peripheral direction; and
a connecting busbar, comprising:
a mounting base, wherein the mounting base is an insulating member;
at least one first connecting member, inserted into the mounting base, wherein the first connecting member comprises at least two first connecting ends, wherein a corresponding one of the at least two first connecting ends is configured to be connected to a corresponding one of the plurality of coils; and
at least one second connecting member, disposed on the mounting base, and comprising at least two second connecting ends, wherein a corresponding one of the at least two second connecting ends is configured to be connected to another corresponding one of the plurality of coils;
wherein the plurality of coils and the connecting busbar are located on the stator assembly or on the rotor assembly.

18. The motor according to claim 17, wherein the motor is configured in a cable output device;
the stator assembly comprises a stator core, a plurality of winding frames are arranged inside the stator core along a peripheral direction of the stator core, and a corresponding one of the plurality of coils comprises a flat wire wound around a corresponding one of the plurality of winding frames; and
the corresponding one of the plurality of coils comprises the flat wire stacked along a thickness direction, and a stacking direction extends toward a central axis of the stator core.

19. The motor according to claim 17, further comprising a heat dissipation fan, and at least one of the rotor assembly or the stator assembly comprises an avoidance portion, and the avoidance portion is configured to mount the heat dissipation fan.

20. The motor according to claim 19, wherein the stator assembly is sleeved on the rotor assembly;
wherein a core of the rotor assembly is annular, and the heat dissipation fan is disposed inside an annular structure of the rotor assembly; or
a gap is defined between an end portion of the stator assembly and the motor housing, and the heat dissipation fan is located in the gap.
